(19) United States
(12) Patent Application Publication
(10) Pub. No.: US 2026/0219649 A1
(43) Pub. Date: Jul. 30, 2026

(54) METHOD FOR MULTIVARIATE TESTING, DEVELOPMENT, AND VALIDATION OF A MATERIAL FOR AN ADDITIVE MANUFACTURING DEVICE

(71) Applicant: Stratasys, Inc., Minnetonka, MN (US)

(72) Inventor: Marshall Douglas Ling, Minnetonka, MN (US)

(21) Appl. No.: 19/515,332

(22) PCT Filed: Aug. 30, 2024
(86) PCT No.: PCT/US2024/044833

§ 371 Date: Apr. 6, 2026

Related U.S. Application Data
(60) Provisional application No. 63/535,874, filed on Aug. 31, 2023.

(51) Int. Cl. G05B 19/4099; B29C 64/386; B33Y 50/00

(52) U.S. Cl. CPC G05B 19/4099; B29C 64/386; B33Y 50/00; G05B 2219/49007

(57) ABSTRACT

One variation of a method for generating a print file for a target part includes, during a first time period: accessing test characteristics of a test build formed of a material and test print parameters executed during fabrication of the test build; deriving functions for the material relating subsets of part characteristics and print parameters; and storing the functions in a material profile for the material. This variation of the method further includes, during a second time period succeeding the first time period: accessing a virtual part model representing the target part formed of the material; based on the set of functions, calculating print parameter ranges for the target part, limited by a target value for a part characteristic received from the user; and serving the print file including the print parameter ranges to an additive manufacturing system for execution.

### CROSS-REFERENCE TO RELATED APPLICATIONS

This Application is a national stage filing of PCT/US24/44833, filed on 30 Aug. 2024, under 35 U.S.C. 371, which claims the benefit of priority of U.S. Provisional Application No. 63/535,874, filed on 31 Aug. 2023, each of which are incorporated in their entirety by this reference.

### TECHNICAL FIELD

This invention relates generally to the field of additive manufacturing and more specifically to a new and useful method for generating a print file for a target part to be executed by an additive manufacturing system, e.g. according to user inputs via a user interface.

### BRIEF DESCRIPTION OF THE FIGURES

FIG. 1 is a flowchart representation of a method;

FIG. 2 is a flowchart representation of one variation of the method;

FIG. 3 is a flowchart representation of one variation of the method;

FIG. 4 is a flowchart representation of one variation of the method;

FIG. 5 is a flowchart representation of one variation of the method; and

FIG. 6 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. METHOD

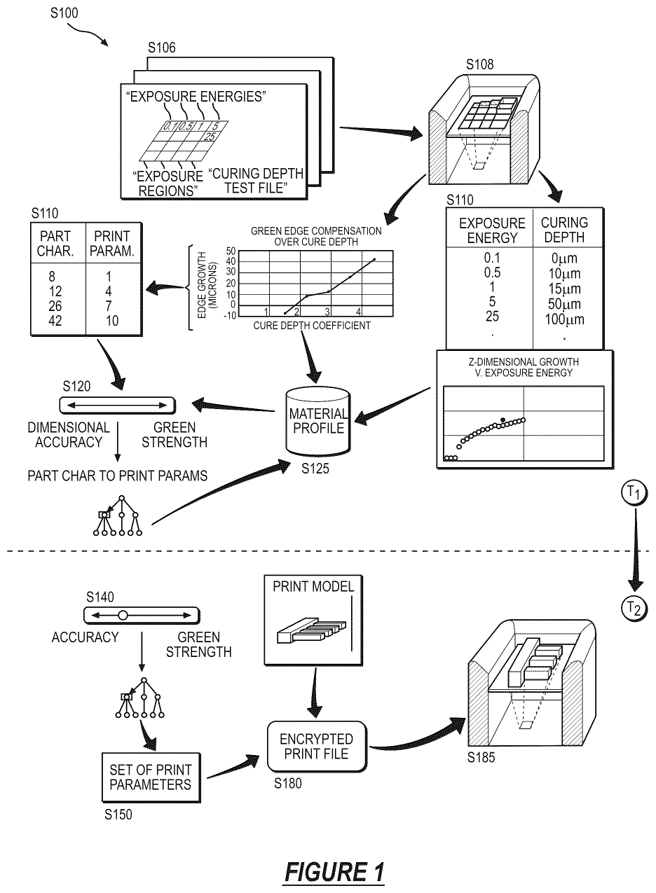

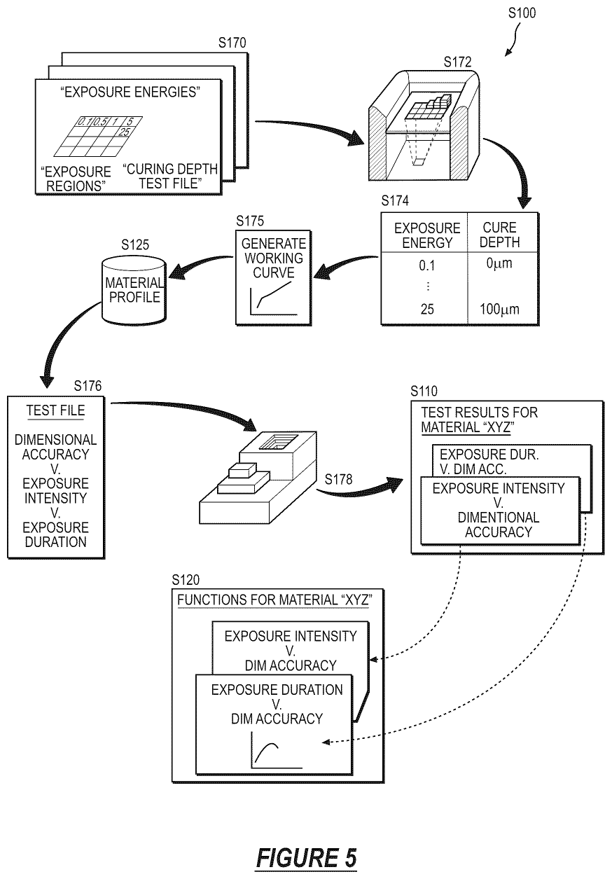

As shown in FIGS. 1-6, a method S100 includes, during a first time period: accessing a set of test characteristics representing dimensional properties and mechanical properties of a set of test builds formed of a material; accessing a set of test print parameters executed by a set of additive manufacturing systems during fabrication of the set of test builds in Block S110; deriving a set of functions for the material relating a subset of part characteristics and a subset of print parameters based on the set of test characteristics, and the set of test print parameters in Block S120; and storing the set of functions in a material profile associated with the material in Block S125.

The method S100 also includes, during a second time period succeeding the first time period: accessing a virtual part model representing the target part formed of the material in Block S130; and, for a first part characteristic in a set of part characteristics, receiving a first target value from a user via a user interface executing on a computing device accessed by the user in Block S140. The method S100 also includes, during the second time period, based on the set of functions: calculating a first set of print parameter ranges of a set of print parameters for the target part, limited by the first target value for the first part characteristic in Block S150; and calculating a second part characteristic range of a second part characteristic in the set of part characteristics, limited by the first set of print parameter ranges. The method S100 also includes, during the second time period: presenting the second part characteristic range of the second part characteristic to the user via the user interface in Block S160; receiving a second target value, for the second part characteristic, within the second part characteristic range from the user via the user interface in Block S140; calculating a second set of print parameter ranges of the set of print parameters for the target part, based on the set of functions and limited by the first target value for the first part characteristic and the second target value for the second part characteristic in Block S150; generating the print file for the target part based on the virtual part model of the target part and the second set of print parameter ranges in Block S180; and serving the print file to an additive manufacturing system for execution during fabrication of an instance of the target part in Block S185.

### 1.1 Variation: User-Adjustable Sliders

As shown in FIGS. 1-6, one variation of the method S100 includes, during a first time period: accessing a set of test characteristics representing dimensional properties and mechanical properties of a set of test builds formed of a material; accessing a set of test print parameters executed by a set of additive manufacturing systems during fabrication of the set of test builds in Block S110; deriving a set of functions for the material relating a subset of part characteristics and a subset of print parameters based on the set of test characteristics, the set of test print parameters in Block S120; and storing the set of functions in a material profile associated with the material in Block S130.

This variation of the method S100 also includes, during a second time period succeeding the first time period, accessing a virtual part model representing the target part formed of the material in Block S130.

This variation of the method S100 also includes, during the second time period, for a first part characteristic in a set of part characteristics: presenting the first part characteristic to a user via a user interface executing on a computing device accessed by the user, the first part characteristic adjacent a first slider, the first slider configured for adjustability by the user in Block S160; and receiving a first target value via adjustment of the first slider by the user in Block S140.

This variation of the method S100 also includes, during the second time period, based on the set of functions: calculating a first set of print parameter ranges of a set of print parameters for the target part, limited by the first target value for the first part characteristic in Block S150; and calculating a second part characteristic range of a second part characteristic in the set of part characteristics, limited by the first set of print parameter ranges in Block S160.

This variation of the method S100 also includes, during the second time period, presenting the second part characteristic range of the second part characteristic to the user via the user interface in Block S160, the second part characteristic adjacent a second slider, the second slider: interposed between a first text box indicating a lower boundary of the second part characteristic range and a second text box indicating an upper boundary of the second part characteristic range; and configured for adjustability by the user.

This variation of the method S100 also includes, during the second time period: receiving a second target value, for the second part characteristic, within the second part characteristic range from the user via the user interface via adjustment of the second slider by the user in Block S140; calculating a second set of print parameter ranges of the set of print parameters for the target part, limited by the first target value for the first part characteristic and the second target value for the second part characteristic in Block S150; generating the print file for the target part based on the virtual part model of the target part and the second set of print parameter ranges in Block S180; and serving the print file to an additive manufacturing system for execution during fabrication of an instance of the target part in Block S185.

### 1.2 Variation: Print Parameters Based on Single User Input

As shown in FIGS. 1-6, one variation of the method S100 includes, during a first time period: accessing a set of test characteristics of a set of test builds formed of a material; accessing a set of test print parameters executed during fabrication of the set of test builds in Block S110; deriving a set of functions for the material relating a subset of part characteristics and a subset of print parameters based on the set of test characteristics, the set of test print parameters in Block S120; and storing the set of functions in a material profile associated with the material in Block S125.

This variation of the method S100 also includes, during a second time period succeeding the first time period: accessing a virtual part model representing the target part formed of the material in Block S130; for a first part characteristic in a set of part characteristics, receiving a first target value from a user via a user interface in Block S140; based on the set of functions, calculating a first set of print parameter ranges of a set of print parameters for the target part, limited by the first target value for the first part characteristic in Block S150; generating the print file for the target part based on the virtual part model of the target part and the first set of print parameter ranges in Block S180; and serving the print file to an additive manufacturing system for execution during fabrication of an instance of the target part in Block S185.

### 2. APPLICATIONS

Generally, Blocks of the method S100 can be executed by a system including a computer system (e.g., computing device) and a manufacturing system (e.g., additive manufacturing device): to generate a test file(s) defining multiple structures and assigning distinct combinations of print parameters to these structures; to serve the test file to the manufacturing system for execution; to access measurements representing physical (e.g., mechanical, geometric, aesthetic) properties of these structures based on execution of the test file by the manufacturing system; and to derive relationships between print parameters and the physical properties; to store these relationships in a profile associated with the material.

Accordingly, Blocks of the method S100 can be executed by the computer system: to receive target physical (e.g., mechanical, geometric, aesthetic) properties of a part to be formed of the material; and to generate a set of print parameters based on these relationships for controlling the manufacturing device to manufacture the part formed of the material and exhibiting physical properties that approximate the target physical properties. Therefore, Blocks of the method S100 can be executed by the computer system to aid a user—exhibiting limited expertise in the manufacturing system—in rapidly calculating a set of print parameters that satisfy design goals.

### 2.1 Target Properties & Interface

Additionally, Blocks of the method S100 can be executed by the computer system: to define controls representing target properties of a structure formed of a particular material; to associate these controls and/or target properties with the physical properties of structures formed based on execution of the test file by the manufacturing system; to derive functions linking the controls with combinations of print parameters based on these relationships; and to store the functions in the profile associated with the material.

Furthermore, Blocks of the method S100 can be executed by the computer system to: expose the controls to a user; access a virtual part model for a future target part; receive a user input of the controls representing target properties of the future target part; convert the user input into a set of print parameters based on the relationships (or “functions”) linking the controls with combinations of print parameters; generate a print file defining the virtual part model and the set of print parameters; and serve the print file to an additive manufacturing system for execution.

In one application, the method S100 can be executed by the computer system: to present a set of part characteristics (e.g., a set of 30 part characteristics) to the user via the user interface; to access a set of nominal values and/or ranges corresponding to the set of part characteristics; and to present each nominal value and/or range adjacent the corresponding part characteristic in the user interface. For example, the computer system can access nominal values: from a user profile (e.g., a preferred dimensional accuracy of +0.1 millimeters); from another material profile linked to a similar (or “analogous”) material; and/or minimum and maximum values derived based on the functions defined for the material. Therefore, Blocks of the method S100 can be executed by the computer system to leverage existing material and/or user profiles to present nominal part characteristic values as a reference for the user when selecting the target values.

In another application, the method S100 can be executed by the computer system: to receive a set of inputs from the user corresponding to target values of a subset of part characteristics; to derive a set of print parameters based on the functions defined for the material and limited by the set of user inputs; to derive the remaining part characteristics based on the functions and limited by the set of print parameters (i.e., limited by the set of user inputs); and to prompt the user to review and accept the derived part characteristics. Therefore, Blocks of the method S100 can be executed by the computer system to aid a user—exhibiting limited expertise in the manufacturing system—in rapidly calculating both a set of part characteristics and a set of print parameters that exhibit target properties specified by the use and satisfy design goals for the target part.

In another application, the method S100 can be executed by the computer system: to receive a user input of a target part characteristic (i.e., target property) of the target part via the user interface (e.g., via adjustment of a slider or input into an empty text box); to derive a set of print parameters based on the functions defined for the material and limited by the user input; to recalculate the nominal values and/or ranges for the remaining target properties based on the functions and limited by the set of print parameters (i.e., limited by the user input); and to present the recalculated nominal values and/or ranges adjacent the corresponding part characteristic upon each successive input by the user.

Accordingly, Blocks of the method S100 can be executed by the computer system (and/or an additive manufacturing system): to enable a user to explicitly and directly select physical characteristics of a workpiece 3D-printed in a particular resin (i.e., a target part), rather than set many (e.g., 30) print characteristics, each of which may have primary, secondary, and tertiary effects on multiple part characteristics. Therefore, the computer system can execute Blocks of the method S100 to reduce uncertainty and ambiguity in print parameter selection for a particular resin and to instead implement a systematic workflow: for transforming the user's specific objectives for a part into specific print parameters likely to achieve these part objectives; and for isolating and resolving conflicting part objectives that are not mutually achievable given characteristics of the particular resin selected for the part.

Thus, the computer system can execute Blocks of the method S100: to obfuscate primary, secondary, and tertiary relationships between print parameters and part characteristics for a resin; to enable a user to directly set part characteristic objectives for a part printed with the resin; and to automatically transform the part characteristic objectives into print parameters executable by an additive manufacturing system to achieve these part characteristic objectives. Therefore, the computer system removes the complexity from the material validation process by: prompting the user to simply select the desired part characteristics; and eliminating the requirement for a user to understand and interact with the underlying print parameters required to achieve the desired part characteristics.

### 2.2 Material Validation

Additionally, Blocks of the method S100 can be executed by the computer system: to facilitate development of novel material chemistries or adaptation of existing material chemistries for stereolithography via the additive manufacturing system; and to derive or characterize material properties for effective additive manufacturing via the additive manufacturing system. More specifically, the computer system can execute an iterative material development process for a photocurable resin- or material-under-test (hereinafter “the material”), wherein each step of the process includes: selection of a set of test variables (or “test print parameters”) (independent or interdependent variables) and a set of material properties dependent on the test variable; generating a test file (e.g., a representation of three-dimensional geometry and accompanying metadata) based the selected set of test variables, material properties, and known characteristics of the material (in uncured, cured, and post-cured states); photocuring a test build based on the test file via the additive manufacturing system; accessing a set of physical measurements of the test build or recorded during the photocuring process of the test build that represent the set of part characteristics; and calculating target values for the selected set of test variables based on the set of physical measurements.

Accordingly, the computer system can extract extensive data from a minimal amount of resin: to validate that the resin meets specified performance requirements; and to automatically generate of a material profile that correlates print parameters with part characteristics. Therefore, by eliminating the need for further testing upon availability of additional resin, the computer system can facilitate rapid implementation of a resin (i.e., a material) to print functional parts that achieve the part characteristic objectives.

### 3. EXAMPLE: NEW MATERIAL VALIDATION

In one example, the computer system can: receive indication from the user of a newly-developed material (e.g., via selection of a “new material validation” module in the user interface); and derive a material profile for the new material. In this example, the computer system can then: present a list of previously-validated materials (or list of material chemistry classes); receive selection of a validated material (or material chemistry class) similar to the new material from the list of previously-validated materials; access nominal functions (i.e., a set of nominal functions relating part characteristics and nominal print parameters for the validated material); access a virtual test model representing a set of test builds; assign print parameter ranges—similar to the nominal print parameter ranges of the validated material—to regions of the virtual test model based on the nominal functions; and generate a print file defining the virtual test model and the print parameter ranges. The computer system can then print a set of test builds via an additive manufacturing system and according to the print file.

Upon completion of a series of validation tests (e.g., destructive strength tests, surface profilometry tests, dimensioning) on the set of test parts, the computer system can access and/or receive test results associated with the set of test builds. The computer system can then: compile the test results into a new set of functions that specifically relate part characteristics and print parameters for the new material; and store the new set of functions in a new material profile for the new material. For example, the computer system can: implement regression or artificial intelligence techniques to detect relationships between: [print parameter 1, 2]< > [part characteristic 1]; and [print parameter 3]< > [part characteristic 2, 3].

Later, when the user (or another user) selects this new material, the computer system (or another instance of the computer system) can: access the new material profile for the new material; load (or derive from the new material profile) maximum ranges of part characteristics that are possible in a part printed with this new material; present the maximum ranges of these part characteristics to the user; and receive a first value (e.g., a target value, minimum value, maximum value, acceptable range) for a first part characteristic, such as a first part characteristic that is most important to the user or most critical for a part printed with the new material.

The computer system can then, based on functions contained in the new material profile: calculate or refine a set of print parameters (or print parameter ranges) required to achieve the first value of the first part characteristic; and calculate or refine ranges that are possible for all other part characteristics if the set of print parameters (or print parameter ranges)—which are required to achieve the first value of the first characteristic—are implemented.

Furthermore, the computer system can: receive a second value (e.g., a target value, minimum value, maximum value, acceptable range) for a second part characteristic from the revised part characteristic ranges; based on functions contained in the new material profile, refine the set of print parameters (or print parameter ranges) required to achieve the first value of the first part characteristic and the second value of the first part characteristic; and, based on functions contained in the new material profile, revise ranges that are possible for all other part characteristics if the set of print parameters (or print parameter ranges)—which are required to achieve the first value of the first characteristic and the second value of the second characteristic—are implemented.

The computer system can repeat this process for additional part characteristics: to finalize a set of part characteristics that are achievable with the new material according to the new material profile; and to refine the set of print parameters required to achieve the values of the part characteristics selected by the user based on the functions contained in the new material profile.

The computer system can then: access virtual part model representing a target part formed of the new material; segment the virtual part model into a set of model layers; and compile the set of model layers and the set of print parameters into a print file for execution by an additive manufacturing system. The computer system can then print the target part via an additive manufacturing system and according to the print file. Therefore, the computer system can: refine available ranges of part characteristics given target part characteristics selected by the user and based on the material profile; and automatically transform target part characteristics set by the user into print parameters, thereby enabling the user to achieve a part that meets the user's objectives without requisite knowledge of the primary, secondary, and tertiary effect of each print parameter on each part characteristic.

Furthermore, the computer system can implement methods and techniques described above: to derive a single set of print parameter ranges for the virtual part model; or to derive multiple sets of print parameter ranges for different layers of the virtual part model.

Accordingly, the computer system can: receive selection of different part characteristic values for different regions of the virtual part model (e.g., bottom, middle, and top regions); derive a unique set of print parameters for each region based on the different values; and assign the unique sets of print parameters to a first sequence of layers of the virtual part model.

### 4. TERMINOLOGY

Generally, a “print parameter” herein refers to a mechanical behavior of the manufacturing system. Each print parameter is controlled by a “print parameter value” or a “print parameter range,” which defines a value and/or range (e.g., an input value, a control value) of the print parameter.

Generally, a “part characteristic” herein refers to a physical (e.g., mechanical, geometric, aesthetic) property of a manufactured structure. Each part characteristic is defined for a target part within a “part characteristic value” or a “part characteristic range,” which defines a value and/or range of the part characteristic.

Generally, a “function” herein refers to a relationship between a print parameter (or a subset of print parameters) and a part characteristic (or a subset of part characteristics).

### 5. SYSTEM

As shown in the FIGURES, a system can include a computer system and a set of manufacturing systems (e.g., a set of additive manufacturing devices). The computer system can communicatively couple to the manufacturing system, such as via a communication network (e.g., wired communication network, wireless communication network, the Internet).

In one implementation, the computer system can interface with the manufacturing system—such as described in U.S. patent application Ser. No. 16/672,415, filed on 1 Nov. 2019, which is incorporated in its entirety by this reference—to polymerize (or “print”) a sequence of layers of material (e.g., resin) to form a three-dimensional target part.

More specifically, the computer system can implement similar methods and techniques described in U.S. patent application Ser. No. 17/173,174, filed on 10 Feb. 2021, which is incorporated in its entirety by this reference, to generate a print file defining a set of print parameters and a set of frames corresponding to cross-sections (e.g., full cross-sections, partial cross-sections) of a virtual part model of a part; and to serve the print file to the manufacturing system to selectively photocure sequential layers of the material—according to the set of print parameters and the set of frames—to form the build.

In one example, the manufacturing system: accesses the set of print parameters defining an exposure intensity and an exposure duration; and projects a total exposure energy of electromagnetic radiation—based on the exposure intensity and the exposure duration—incident to the layers of material during a photocuring phase of an additive manufacturing process.

In another example, the manufacturing system accesses the set of print parameters including: layer thickness; exposure delay; exposure duration; separation distance; advancement delay; cure depth coefficient; separation start distance; separation start speed; approach end distance; approach end speed; scaling factor; and/or minimum spacing.

In these examples, the manufacturing system executes the print file to form the build exhibiting a set of part characteristics representing mechanical, geometric, and/or aesthetic properties of the build, such as: a feature resolution metric of the green and/or post-cured material; a surface finish metric of the green and/or post-cured material (e.g., surface roughness); tensile mechanical properties of the green and/or post-cured material (e.g., ultimate tensile strength, elongation at break, elastic modulus); shear mechanical properties of the green and/or post-cured material (e.g., shear strength, shear modulus); compressive mechanical properties of the green and/or post-cured material (e.g., characteristic strength); maximum overhang angle of the green and/or post-cured material; color and/or optical characteristics of the post-cured material; UV stability and/or durability of the post-cured material; etc.

In another implementation, the manufacturing system includes a set of additive manufacturing systems (i.e., one or more), each manufacturing system configured to execute one or more steps of the method S100. For example, a first additive manufacturing system photocures the set of test builds, a second additive manufacturing system derives the set of functions for the material relating the subset of part characteristics and the subset of print parameters, and a third additive manufacturing system executes the print file during fabrication of the instance of the target part.

### 6. MATERIAL VALIDATION

Generally, the computer system can execute a material validation procedure: to generate a test file defining a set of print parameters—including a subset of print parameters modulated between predefined ranges of test values—and a virtual test model representing a test build and characterized by a predefined geometry; to print a sequence of layers of the material according to the print file to form the test build; to access a set of measurements characterizing a subset of test characteristics exhibited by the test build; to derive a function defining a relationship between these test values of the subset of print parameters and the subset of test characteristics, in a set of test characteristics, based on the set of measurements; and to store the function in a material profile associated with the material.

Generally, the computer system can execute validation procedures—such as those described in U.S. patent application Ser. No. 17/173,174—to define a set of functions characterizing a set of relationships between distinct combinations of print parameters and resultant part characteristics of structures formed according to these distinct combinations of print parameters. For example, the computer system can execute a sequence of validation procedures during an initial time period (or “validation period”).

In one implementation, the computer system can store each function in the set of functions in the material profile for the material. Additionally, the computer system can store sets of measurements and/or ranges of values (e.g., minimum value, maximum value) of part characteristics of structures formed through the sequence of validation procedures.

In one example, the computer system stores a set of material properties including: critical energy; depth of penetration; viscosity at a predefined temperature (e.g., 25 degrees Celsius); edge compensation; shrinkage compensation (e.g., green shrinkage compensation, final shrinkage compensation); and/or dimensional offset (e.g., Z-dimensional offset); etc.

In another example, the computer system stores the set of material properties representing the material in a resin phase (or “uncured material”) and a photocured phase (or “photocured material”) in a green state. In this example, the computer system stores the set of material properties further including a material type, a function correlating exposure energy and polymerized film thickness, a temperature-viscosity curve, a critical energy, a specific heat, a specific gravity, a thermal expansion and/or contraction coefficient, a curing depth, a UV penetration depth of the uncured build material, and/or additional cure characteristics of the resin such as chemical reaction thermodynamics, polymerization shrinkage characteristics, residual/latent cure characteristics post-exposure to electromagnetic radiation, edge-curing characteristics (e.g., molecular building at perimeters of cross-sectional geometries), and/or through-curing characteristics (e.g., interlayer binding characteristics), etc.

### 6.1 Test Characteristics

Generally, the computer system can generate a test file for a set of test builds based on a set of test print parameters and a set of target test characteristics, which are the measurable dependent variables corresponding to test builds of the set of test builds. Thus, by identifying the test build of a set of test builds that most closely exhibits a set of target values for the selected set of part characteristics (based on a set of development criteria), the computer system can identify target ranges of the set of test print parameters corresponding to the test build. Alternatively, upon failing to identify any test build of the set of test builds that exhibits the set of target values, the computer system can trigger a reformulation prompt and halt the iterative material development process.

The computer system can select certain variables as either a test variable (i.e., a test print parameter) or a material parameter (or a “material property”) based on the current level of characterization of the material. For example, the computer system can initially designate depth of cure as a part characteristic depending on the test variable of exposure energy. However, upon characterizing the relationship between exposure energy and depth of cure of the material (by calculating the working curve of the material via a depth of cure test), the computer system can then cooperate with the additive manufacturing system to vary the depth of cure as a test variable in subsequent iterations of the iterative material development process. Thus, any of the following examples of part characteristics can be selected as a test variable upon sufficient characterization of these part characteristics relative to other more fundamental test variables.

The computer system can characterize any of the following set of material properties including: a depth of cure of the material, a temperature-viscosity curve of the uncured material, horizontal dimension scale factors for the green and/or post-cured material, vertical dimension scale factor for the green and/or post-cured material, an edge building characteristic of the green and/or post-cured material, a warpage factor of the green and/or post-cured material, a surface finish metric of the green and/or post-cured material (e.g., surface roughness), tensile mechanical properties of the green and/or post-cured material (e.g., ultimate tensile strength, elongation at break, elastic modulus), shear mechanical properties of the green and/or post-cured material (e.g., shear strength, shear modulus), compressive mechanical properties of the green and/or post-cured material (e.g., characteristic strength), maximum overhang angle of the green and/or post-cured material, color and/or optical characteristics of the post-cured material, UV stability and/or durability of the post-cured material, etc. Thus, the computer system can generate a test file and photocure a corresponding test build that characterizes the dependence of one or more of these part characteristics on the selected test variable, as is further described below.

In one implementation, the computer system can access a selection of a set of test variables and/or a set of part characteristics based on a predetermined development flow for the iterative material development process. More specifically, the computer system can establish a graph (e.g., a directed graph or tree) that defines an order of test variables and part characteristics based on the results of prior iterations of the iterative development process.

In this implementation, Blocks of the method S100 can include: generating a cure characterization test file defining a first set of test builds arranged across a build area, each test build characterized by a total exposure energy value in Block S170; photocuring the first set of test builds by, for each test build, selectively exposing the material to a quantity of exposure energy corresponding to the total exposure energy value characterizing the test build in Block S172; accessing a first set of physical measurements representing a depth of cure for each test build in Block S174; calculating a working curve of the material based on the first set of physical measurements in Block S175; for assessing a part characteristic generating a second test file based on the working curve of the material, the second test file defining the set of test builds in Block S176; and photocuring the set of test builds based on the second test file in Block S178.

For example, the computer system can access a development flow that defines a first test build, second test builds based on the results of the first test build, third test builds based on the results of each second test build, etc. Additionally, the computer system can access a development flow that establishes development criteria at transitions between test builds in order to evaluate whether to continue additional iterations of the iterative material development process or to halt the iterative material development process and generate a reformulation prompt.

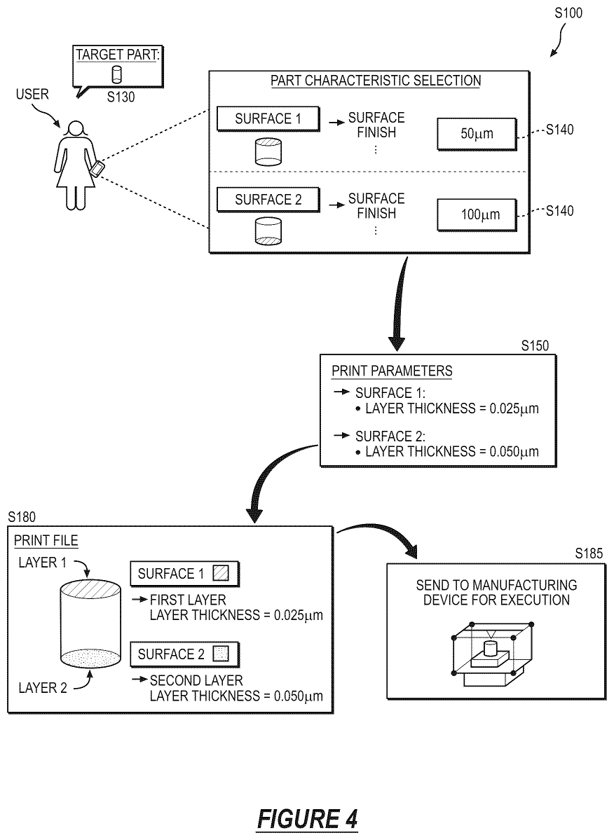

In one example development flow, as shown in FIG. 4, during the initial time period, the computer system can: access a first selection of total exposure energy, as a first test variable, and cure depth, as a first part characteristic; generate a cure characterization test file defining a set of test builds arranged across a build area, each test build in the set of test builds characterized by a total exposure energy value; photocure a cure characterization test build by, for each test build in the set of test builds of the cure characterization test file, selectively exposing the material to a quantity of exposure energy corresponding to the total exposure energy value characterizing the test build; and access a first set of physical measurements representing a depth of cure for each test build in the set of test builds; and calculate a working curve of the material based on the first set of physical measurements. Upon calculating the working curve of the material, and therefore the minimum depth of cure, the computer system can reference the development flow to access a second test variable and a second part characteristic. For example, the computer system can access layer thickness as a second test variable and a measure of dimensional accuracy (e.g., horizontal scaling factor, edge building characteristic) as a second part characteristic for a second test build. In another example, the computer system can access, from the development flow, exposure energy profile as a second test variable and elastic modulus as a second part characteristic for a second test build.

In one implementation, the computer system can, via a development flow, access a different test variable and/or a different part characteristic based on the calculated target range of the test variable of the previous iteration of the iterative material development process and/or based on the corresponding range of the part characteristic of the previous iteration of the iterative material development process. Thus, the computer system can progress through the development flow based on the current level of characterization of the material. For example, in response to calculating that the critical energy of the material is greater than or less than a predetermined critical energy range, the computer system can access, via the development flow, the exposure energy profile as a second test variable for a subsequent iteration of the iterative material development process. Additionally or alternatively, upon calculating a target range of a test variable that is wider than a predetermined threshold range defined by the development flow, the computer system can repeat the same test as in the previous iteration of the iterative development process and change the discrete values of the test variable corresponding to each test build of the test build in order to narrow the target range of the test variable and improve characterization of the corresponding part characteristic.

Additionally, the computer system can generate a development flow in response to receiving a user-established priority or ranking of part characteristics (via the user interface). Thus, the computer system can generate a development flow that prioritizes certain test variables and part characteristics early in the iterative development process, thereby reducing the number of testing iterations prior to characterizing high-priority part characteristics. For example, the computer system can receive a ranking of part characteristics from a user that indicates a target elastic modulus for the material. The computer system can therefore generate a test build that enables characterization of the elastic modulus of the material as a second test, directly after characterization of the working curve of the material.

### 6.2 Test Files

As shown in FIG. 1, upon accessing a selection of a set of test variables and a set of part characteristics (either via user input or via a development flow), the computer system can generate a test file (a virtual representation of the test build) based on the selection and based on any prior characterization of target ranges for test variables and/or prior characterization of part characteristics. More specifically, the computer system can generate a first test file based on a first selection, the first test file defining a first set of test builds, each test build in the first set of test builds characterized by a value of a first test variable. Likewise, for a subsequent iteration of the iterative material development process, the computer system can generate a second test file based on the second selection, the second test file defining a first target value of the first test variable within the first target range of the first test variable and defining a second set of test builds, each test build in the second set of test builds characterized by a value of the second test variable. Thus, based on the selection of a test variable and a part characteristic, the computer system can generate a test file defining a geometry that enables measurement of the selected part characteristic within discrete test builds, where each test build is subject to a discrete value of the selected test variable.

Generally, the computer system generates a test file that defines a three-dimensional virtual representation of the geometry of a test build, the locations of set of test builds relative to the geometry of the test build, and the specific values of the set of test variables characterizing each test build in the set of test builds. Therefore, the computer system can generate the test file as a standard computer-aided design file, such as an STL file, in combination with a separate file, such as CSV or XML file, that designates the test builds and the values of the set of test variables characterizing each test build. Alternatively, the computer system can generate the test file in a proprietary format that defines the test builds, corresponding test variable values, and the geometry of the test build.

In one implementation, the computer system generates the test file by generating a test build geometry and repeating this test geometry for each discrete test build in the set of test builds. In this implementation, the computer system can generate a test build geometry based on the selected part characteristic the test. Upon selecting the test build geometry, the computer system can arrange each instance of the test build geometry within a discrete test build that defines a subsection of the available build volume of the additive manufacturing system. Generally, the computer system arranges test builds within the build volume based on whether the additive manufacturing system can modulate the selected test variable on an interlayer basis or on an intralayer basis.

In one implementation, in response to accessing a selection of an exclusively interlayer test variable, the computer system can arrange the set of test builds and corresponding test build geometry in a vertical stack such that each layer is characterized by a single value of the test variable. In this implementation, the computer system can generate connective geometry between instances of the test build geometry positioned within buffer regions occupying intermediate layers between test builds in order to ensure that all sections of the test build remain adhered to the build platform while photocuring the test build. More specifically, the computer system can generate a test file based on a selection of the test variable, the test file defining a set of test builds, each test build in the set of test builds characterized by a value of the test variable and defining a subset of layers of the first test file. Thus, the computer system can generate a test file representing a test build for testing an interlayer test variable.

Additionally or alternatively, in response to accessing a selection of an intralayer test variable, the computer system can generate a test file defining a two-dimensional (e.g., varying in the horizontal plane) or three-dimensional grid (e.g., varying in the horizontal and vertical planes) arrangement of test builds within the build volume. For intralayer test variables, the computer system can also generate test files defining interlocking test builds in order to reduce wasted volume within the build volume and to maximize a number of test builds defined by the test file. More specifically, the computer system can generate a test file based on the selection of an intralayer test variable, the test file defining a set of test builds, each test build in the set of test builds characterized by a value of the intralayer test variable and defining a two-dimensional intralayer area for each layer of the test file.

In one implementation, in response to accessing a selection of multiple test variables, one of which is an intralayer, the computer system can generate a test file defining a set of test builds arranged in a three-dimensional grid pattern and characterized by a first intralayer test variable varying in a horizontal dimension and a second interlayer test variable varying in a vertical dimension.

In another implementation, the computer system can, for each test build defined by the test file, modify the test build geometry to include a label (e.g., in the form of embossed or debossed lettering) indicating the value of the test variable characterizing the test build. Alternatively, the computer system can, for each test build defined by the test file modify the test build geometry to include an identifying feature configured to engage a test fixture. Thus, the computer system can generate test files that distinguish otherwise identical test build geometries from one another, thereby facilitating manual physical measurement of the part characteristics.

In yet another implementation, the computer system can select the discrete values of the test variables assigned to each test build of the test file based on an estimated target value or an estimated target range of the test variable for the material based on known chemical or physical properties of the material. The computer system can then generate a set of discrete values corresponding to the set of test builds of the test file such that the values are distributed (e.g., normally distributed, evenly distributed) about the estimated target value of the test variable or over the estimated target range of the test variable. In response to identifying that a target value of a part characteristic roughly corresponds to a particular value of the test variable or would result from a value of a test variable between two discrete values of the test variable selected for a first test build, the computer system can generate a second test file with the same geometry but with a refined range of discrete values of the testing parameter. Thus, through successive iterations of a single test build, the computer system can narrow a target range of the test variable that corresponds to a target range of the part characteristic.

In yet another implementation, instead of generating a test file defining a set of discrete test builds, the computer system can continuously (on a per-layer or per-pixel basis) vary the set of test variables over the geometry of the test build. In this implementation, the computer system can generate a test file that defines a single test build with a continuously varying set of test variables in one or more dimensions. For example, the computer system can generate a test file that varies a first test variable in the set of test variables along a first horizontal dimension, a second test variable in the set of test variables along a second horizontal dimension, and a third test variable in the set of test variables in a vertical dimension.

### 6.3 Test Builds

Generally, upon generating a test file, the computer system can cooperate with the additive manufacturing system to photocure a test build based on the test file. More specifically, the computer system can photocure a first test build based on the first test file according to the value of the first test variable characterizing each test build in the first set of test builds in Block S178; and, for subsequent test builds, the computer system can photocure a second test build based on the second test file according to the value of the second test variable characterizing each test build in the second set of test builds and the first target value of the first test variable. In particular, the computer system can instruct the additive manufacturing system to execute a series of build cycles based on the test file in order to manufacture the test builds from a material reservoir containing the material. Thus, the computer system can generate a succession of test builds, each varying a distinct test variable and/or measuring a distinct part characteristic.

### 6.4 Physical Measurements

Generally, the computer system can access a set of physical measurements representing a value of the part characteristic for each test build. More specifically, the computer system can access a first set of physical measurements of a first test build, the first set of physical measurements representing a value of a first part characteristic for each test build in the first set of test builds in Block S110; and, for a subsequent iteration of the iterative material development process, the computer system can access a second set of physical measurements of a second test build, the second set of physical measurements representing a value of the second part characteristic for each test build in the second set of test builds. Thus, for each iteration of the iterative material development process, the computer system can access a set of physical measurements representing values of the part characteristic in response to variations in the test variables across the set of test builds in the test build. The particular physical measurements that correspond to particular build geometries are described in further detail below.

Generally, the set of physical measurements represent the selected set of part characteristics in that each physical measurement in the set of physical measurements either directly corresponds to a value of a part characteristic or that the computer system can calculate a value of a part characteristic as a function of some subset of physical measurements in the set of physical measurements.

In one implementation, the computer system accesses the set of physical measurements for a test build as manual input from the user (via the GUI or API associated with the computer system). In this implementation, the computer system can receive a CSV or other text-based file indicating the physical measurement corresponding to each test build in the set of test builds. In another implementation, the computer system accesses the set of physical measurements from a third-party measurement device or measurement fixture configured to communicate with the computer system via a local or wide area network or via a direct I/O port connected to the computer system.

Alternatively, the computer system can access the set of physical measurements via the sensor suite of the additive manufacturing system prior to removal of the test build from the build chamber of the additive manufacturing system. For example, the computer system can, at the additive manufacturing system, capture an image of the test build; and extract a set of physical measurements based on the image of the test build, the set of physical measurements representing the value of the part characteristic for each test build in the first set of test builds. Thus, the computer system can minimize the number of manual steps required from the user in order to progress from one iteration of the iterative material development process to the next.

In particular, the additive manufacturing system can reference the known geometry of the test build and the known position of the set of image sensors and/or other optical sensors included within the additive manufacturing system to estimate individual physical measurements of features of the test build by executing computer visual and remote sensing techniques. Additionally, the additive manufacturing system can utilize ultrasonic, multispectral, or depth sensor data to provide additional physical measurements of physical features of the test build.

### 6.5 Cure Characterization Test File

In response to accessing a selection of exposure energy as a test variable and cure depth as a part characteristic, the computer system generates a cure characterization test file for the material based on an estimated critical energy of the material and a set of exposure durations within an acceptable operating range of the additive manufacturing system. More specifically, the computer system can generate a cure characterization test file defining a set of test builds arranged across a build area, each test build in the set of test builds characterized by a total exposure energy value. Thus, the computer system can generate a cure characterization test file configured to provide examples of the cure depth over a range of exposure energy values. Because the exposure energy irradiated toward a test build of the material is equal to an exposure intensity multiplied by an exposure duration, when generating the cure characterization test file, the computer system can hold either exposure intensity or exposure duration constant while varying the other parameter. For example, the computer system can: generate a cure characterization test file including a single layer and defining a set of test builds, each characterized by an exposure duration in a range of exposure durations and one exposure intensity. Alternatively, the computer system can generate a cure characterization test file including a single layer and defining a set of test builds, each characterized by an exposure intensity in a range of exposure intensities and one exposure duration.

The cure depth of most material chemistries is a logarithmic function of the form:

$${C}_{d} = {D}_{p} ln ( \frac{{E}_{m ax}}{{E}_{c}} )$$

where C_{d} is the cure depth, Dₚ is the penetration depth parameter, Eₘₐₓ is the energy incident to the material at the build interface, and E_{c} is the critical energy at which measurable photocuring occurs in the material. Thus, the computer system can generate a cure characterization test file defining a set of test builds characterized by exponentially increasing energy levels in order to obtain an accurate fit when calculating the working curve for the material. Alternatively, the computer system can generate a cure characterization test file defining a set of test builds characterized by energy levels distributed within the operating range of the additive manufacturing system in order to provide a more accurate fit within a range of energy levels that can be realistically produced by the additive manufacturing system during the additive manufacturing process.

In one implementation, the computer system generates a cure characterization test file defining a set of test builds characterized by a square or rectangular shape and arranged in a two-dimensional grid pattern across the build interface such that, upon photocuring a cure characterization test build corresponding to the cure characterization test file, the computer system creates a contiguous layer despite differing cure depths within the same layer. Alternatively, the computer system can generate a cure characterization test file defining a set of test builds separated by a buffer region in order to create more distinct divisions between test builds of the cure characterization test file and enabling easier identification and/or measurement of the test builds. In this alternative implementation, the computer system can define a grid structure supporting the cure characterization test build resulting from the cure characterization test file. Additionally, the computer system can specify that the grid structure of the cure characterization test file is characterized by the highest energy level in the set of energy levels characterizing the set of test builds. Thus, upon photocuring the cure characterization test file, the computer system can ensure that the cure characterization test build results in a single piece instead of multiple, separate pieces.

Generally, the computer system can generate the cure characterization test build according to the cure characterization test file in order to create a single layer of photocured material at various thicknesses corresponding to the set of energy levels assigned to each test build defined by the cure characterization test build. More specifically, the computer system can photocure a cure characterization test build by, for each test build in the set of test builds of the cure characterization test file, selectively exposing the material to a quantity of exposure energy corresponding to the exposure energy value characterizing the test build. More specifically, the computer system can photocure a cure characterization test build by, for each test build in the set of test builds of the cure depth build file, selectively exposing a corresponding test build of the material at a build interface to the exposure energy characterizing the test build.

Because the purpose of the cure characterization test build is to determine the cure depth of the material when exposed to a range of energy levels, the computer system can enable the thickness of the single layer to vary by retracting the build platform from the build window. Therefore, when the computer system photocures the cure characterization test build, the single layer (of varying thickness) adheres directly to the build platform, enabling the computer system to optically or mechanically measure the cure depth across the test builds of the cure characterization test build or enabling a user to perform these measurements. Alternatively, a user may peel the cure characterization test build from the build window in order to measure the cure depth across the various test builds of the cure characterization test build.

Upon photocuring the cure characterization test build, the computer system can then access a set of physical measurements representing the thicknesses of the cure characterization test build (e.g., the depth of cure) within each test build and calculate the working curve for the material based on this set of physical measurements. More specifically, the computer system can access a first set of physical measurements representing a depth of cure for each test build in the set of test builds. In one implementation, the computer system accesses a set of manually derived depth of cure measurements recorded by a user via a set of calipers. Alternatively, the computer system can automatically extract the set of depth of cure measurements via a depth sensor integrated with the additive manufacturing system.

Upon accessing the set of depth of cure measurements, the computer system can generate a working curve for the material based on these physical measurements of the cure characterization test build by fitting the depth of cure measurements with a logarithmic function (i.e., logarithmic regression) in order to determine a target exposure energy level corresponding to a target layer thickness for the additive manufacturing system. More specifically, the computer system can calculate a working curve based on a first set of physical measurements of the cure characterization test build. In one implementation, the computer system can automatically measure the depth of each test build of the cure characterization test build by utilizing optical distance measurement via an integrated camera or laser distance measurement via a laser measurement device positioned above the build window. Alternatively, a user may obtain these physical measurements and store the resulting data in a medium accessible to the computer system. The computer system can then access these physical measurements in order to calculate the working curve for the material. In either case, the computer system accesses the physical measurements as a series of two-dimensional data points indicating the depth of cure corresponding to a particular exposure energy level. The computer system can then perform logarithmic least squares region in order to calculate the value of Dₚ and E_{c}.

In one implementation, upon calculating the working curve for a material under test, the computer system can utilize the working curve (e.g., the values of Dₚ and E_{c}) to predict a target value of Eₘₐₓ (i.e., a target exposure energy level) that results in a particular cure depth corresponding to a target layer thickness.

The computer system can select this target layer thickness based on a designed or preferred resolution or build speed of the additive manufacturing system. Alternatively, the computer system can receive a target layer thickness via input from the user. Upon selecting this target layer thickness, the computer system can calculate the corresponding target exposure energy according to the calculated working curve equation. Alternatively, the computer system can calculate a critical energy of the material (corresponding to a minimum layer thickness) based on the first set of physical measurements of the cure characterization test build and a target layer thickness.

In this variation, the computer system can execute a second test file to the cure characterization test file in order to characterize a relationship between a chosen part characteristic and exposure energy profiles characterized by exposure energies greater than the target exposure energy of the material calculated based on the cure characterization test file. More specifically, the computer system can: generate a second test file based on a selection of a part characteristic and the target exposure energy of the material, the second test file defining a set of test builds, each test build in the set of test builds characterized by an exposure energy profile corresponding to a total exposure energy value greater than the target exposure energy of the material; and photocure the second test build by selectively exposing each test build in the set of test builds to an exposure energy profile based on the exposure energy profile of the test build. Thus, the computer system can calculate a target exposure energy profile for the material based a second test build. The computer system can select the particular test build geometry of the second test build based on a selected high-priority part characteristic accessed from a development flow for the iterative material development process or via user input.

### 6.6 Dimensional Accuracy Test Build

The computer system can generate a dimensional accuracy test build as a first or second test build in the iterative material development process based on a selection of a dimensional accuracy part characteristic such as an intralayer scaling factor or an edge building characteristic. More specifically, based on a selection of an intralayer scaling factor (e.g., horizontal scaling factor) as the part characteristic or based on a selection of an edge building characteristic as the part characteristic, the computer system can generate a test file defining, for each test build in the set of test builds: a positive stepped pyramid, each level of the positive stepped pyramid characterized by a positive target dimension; and a negative stepped pyramid, each level of the negative stepped pyramid characterized by a negative target dimension. Alternatively, based on selection of exposure energy profile as a test variable, the computer system can generate a test file defining, for each test build in the set of test builds: a positive stepped pyramid, each level of the positive stepped pyramid characterized by a positive target dimension; and a negative stepped pyramid, each level of the negative stepped pyramid characterized by a negative target dimension. Thus, the computer system utilizes the step pyramid test build geometry to provide a large number of opportunities for dimensional measurement within a small volume because each level of the positive and negative step pyramid is characterized by a target dimension in each of the two dimensions of the horizontal plane. Additionally, by including both a positive step pyramid and a negative step pyramid within the test build geometry the computer system can compare the positive dimensional accuracy of the material to the negative dimensional accuracy of the material within the same test build.

Upon generating the dimensional accuracy test file, the computer system can photocure a dimensional accuracy test build according to the dimensional accuracy test file. More specifically, the computer system can, for each test build in the set of test builds: photocure the positive stepped pyramid according to the test variable value characterizing the test build; and photocure the negative stepped pyramid according to the test variable value characterizing the test build. Alternatively, in response to selection of exposure energy profile as the test variable, the computer system can, for each test build in the set of test builds: photocure the positive stepped pyramid according to the test variable value characterizing the test build; and photocure the negative stepped pyramid according to the test variable value characterizing the test build.

After photocuring the dimensional accuracy test build, the computer system can access a set of physical measurements for each test build (or test build in implementations in which exposure energy profile is selected as the test variable), where each physical measurement corresponds to a dimension of one step of the positive or negative stepped pyramid in the test build. More specifically, the computer system can access, for each test build in the set of test builds: a set of positive measured dimensions corresponding to the positive target dimension of each level of the positive step pyramid; and a set of negative measured dimensions corresponding to the negative target dimension of each level of the negative step pyramid. Thus, for each stepped pyramid of the dimensional accuracy test build, the computer system can execute a linear regression to estimate the intralayer scale factor and the edge building characteristic according to the following equations:

$${y}_{+}^{′} = {m}_{y} {p}_{y} {y}_{+} + k and$$

$${y}_{-}^{′} = {m}_{y} {p}_{y} {y}_{-} - k$$

wherein y′₊ represents positive measured dimensions, y₊ represents positive target dimensions, y′₋ represents negative measured dimensions, y₋ represents negative target dimensions, my represents the intralayer scale factor, p_{y} represents the device-specific scale factor (e.g., a calibrated value characterizing the additive manufacturing system), and k represents the edge building characteristic of the material.

Therefore, the computer system can generate a data pair of a target dimension and a measured dimension for each step of a stepped pyramid and fit the set of data pairs based on the above-described linear equations. Thus, the computer system can characterize variations in the intralayer scale factor and the edge building characteristic relative to changes in a test variable.

In one implementation, the computer system can calculate the intralayer scale factor for each test build of the dimensional accuracy test build while the test build is still in the green state. Alternatively, the computer system can calculate the intralayer scale factor for each test build of the dimensional accuracy test build after post-curing of the test build, thereby accounting for additional intralayer shrinkage that may occur during the post-curing process for the material.

Once the computer system has calculated an intralayer scale factor and/or an edge building characteristic for each test build of the dimensional accuracy test build, the computer system can identify a target range of the test variable that corresponds to satisfactory values of these part characteristics. For example, the computer system can access a target intralayer scale factor and/or a target edge building characteristic based on the application of the material. Thus, the computer system can calculate a target range of the test variable specific to an intended application of the material. More specifically, the computer system can: for each test build in the set of test builds, calculate a measured intralayer scaling factor based on the set of positive measured dimensions for the test build and the set of negative measured dimensions for the test build; select a subset of satisfactory test builds based on the measured intralayer scaling factor for each test build in the set of test builds; and identify the target range of the test variables based on the value of the test variable characterizing each test build in the subset of satisfactory test builds. Additionally or alternatively, the computer system can: for each test build in the set of test builds, calculate a measured edge building characteristic based on the set of positive measured dimensions for the test build and the set of negative measured dimensions for the test build; select a subset of satisfactory test builds based on the measured edge building characteristic for each test build in the set of test builds; and identify the target range of the test variables based on the value of the test variable characterizing each test build in the subset of satisfactory test builds. Thus, the computer system can identify a target range of the test variable that corresponds to satisfactory compensation values for the material for use in a particular application.

### 6.7 Vertically Tiered Test Build

The computer system can generate a vertically tiered test file and photocure a corresponding vertically tiered test build defining a set of test builds, each of which defines horizontally oriented sections of a cylinder, column, or another prism geometry vertically stacked on one another. Generally, the computer system can execute the vertically tiered test build in response to accessing a selection of an interlayer test variable (which can only vary relative to the vertical plane), such as bulk resin temperature, maximum inflation pressure, and/or maximum retraction force, exposure delay, advancement rate, or in response to a receiving selection of a part characteristic such as surface roughness parameter or any other part characteristic that can be easily characterized based on physical measurements of a cylindrical or columnar shape. However, the computer system can also test intralayer test variables via the vertically tiered test build.

More specifically, the computer system can, in response to accessing a selection of a surface roughness parameter as the part characteristic; based on the selection, generate a vertically tiered test file defining, for each test build in the set of test builds, a horizontal section of a contiguous column; and, for each test build in the set of test builds, photocure the horizontal section of the contiguous column for the test build according a value of the test variable characterizing the test build.

Upon photocuring the vertically tiered test build, the computer system can access a set of physical measurements corresponding to a surface roughness parameter in order to characterize the effect of the test variable on the surface roughness of the cured material. More specifically, the computer system can, for each test build in the set of test builds, access a measured surface roughness parameter of the horizontal section of the contiguous column. Once the computer system has accessed the measured surface roughness parameter for each test build, the computer system can: select a subset of satisfactory test builds based on the measured surface roughness parameter for each test build in the set of test builds; and identify the target range of the test variable based on the value of the test variable characterizing each test build in the subset of satisfactory test builds.

In one implementation, the computer system can generate a vertically tiered test file defining a different cross-section (such as a square, rectangular, or other cross section), thereby defining a non-cylindrical column. Additionally, or alternatively, the computer system can generate a vertically tiered test file with buffer regions between the test builds of the vertically tiered test file to more effectively isolate transition effects between values of the test variable applied to adjacent test builds.

Accordingly, the computer system can generate a material profile defining correlations between: print parameters (e.g., print layer thickness, light-shell thickness and step size, light-shell exposure intensity, light-shell exposure duration); print outcomes (e.g., intra- and inter-layer dimensional tolerance, polymerization bleed between print layers, surface finish, surface texture, green strength); and part characteristics (e.g., cross-sectional of features, vertical and horizontal aspect ratios of features). Therefore, the computer system can: receive a user input representing target characteristics of a future build; based on the correlations defined in the material profile, convert this user input into a set of print parameters that control the manufacturing system to form the build exhibiting the target characteristics; generate a print file defining the set of print parameters; and serve the print file to the manufacturing system for execution.

### 6.8 Material Validation Based on an Analogous Material

In one variation, the computer system can define the set of print parameter ranges for the test build based on print parameter ranges defined for an analogous material, such as a material exhibiting one or more similar chemical properties (e.g., viscosity, photoinitiator concentration, and/or cure depth), mechanical properties (e.g., tensile strength and hardness), thermal properties (e.g., glass transition temperature and thermal expansion), and/or shrinkage rate. In this implementation, Blocks of the method S100 can include: accessing a first material property of the material in Block S112; identifying a second material associated with a second material property analogous to the first material property in Block S114; assigning the set of test print parameters to the set of test builds based on a second set of test print parameters executed by the set of additive manufacturing systems during fabrication of a second target part formed of the second material in Block S104; generating a test print file for the set of test builds formed of the material based on the set of print parameters in Block S106; and serving the test print file to the set of additive manufacturing systems for execution during fabrication of the set of test builds in Block S108.

In particular, in this variation, the computer system can: access a first material property of the material; identify a second material associated with a second material property analogous to the first material property; assign the set of test print parameters based on a second set of print parameters executed by the set of additive manufacturing systems during fabrication of a second target part formed of the second material; generate a test print file for the set of test builds formed of the material based on the set of test print parameters; and serve the test print file to the additive manufacturing system for execution during fabrication of the set of test builds.

For example, the computer system can: access a viscosity of 200 centipoise of the material; identify a second material associated with a viscosity of 200 centipoise; access a layer thickness of 75 microns and an exposure duration of twelve seconds per layer from the second set of print parameters; generate the test print file for the set of test builds formed of the material including the layer thickness of 75 microns and the exposure duration of twelve seconds per layer; and serve the print file to the additive manufacturing system for execution during fabrication of the set of test builds. Therefore, the computer system can leverage analogous materials to establish reference testing parameters for a material undergoing validation, thereby reducing resources required to validate a new material.

### 6.9 Example Validation Procedure

Generally, the computer system can execute a “Z-growth characterization” validation procedure to characterize a relationship between total incident exposure energy (or “exposure energy”) applied to the material and a polymerized film thickness.

In one implementation, the computer system can generate a first test file defining a first set of print parameters and a first virtual test model characterizing a first geometry of a first test build, the first set of print parameters including: a first print parameter representing an exposure intensity (e.g., five milliwatt); and a second print parameter—representing an exposure duration—modulated between a first set of test values within a first range (e.g., from 0.5 seconds to ten seconds at every half-second interval, from ten seconds to 50 seconds at every 10-second interval). More specifically, for each test build in the set of test builds, the computer system can generate the first test file instructing the manufacturing system to project an exposure energy of electromagnetic radiation—based on the exposure intensity and a test value in the set of test values of the exposure duration—incident to the test build. The computer system can serve the first test file to the manufacturing system.

In another implementation, the manufacturing system can execute the print file to form the first test build according to the first set of print parameters and the first virtual test model.

For example, the manufacturing system can project a first exposure energy of ten millijoules of electromagnetic radiation—based on the exposure intensity of five milliwatts and a first test value of two seconds of exposure duration—incident to a first test build in the set of test builds. In this example, the manufacturing system can project a second exposure energy of 12.5 millijoules of electromagnetic radiation, based on the exposure intensity of five milliwatts and a second test value of 2.5 seconds of exposure duration, incident to a second test build in the set of test builds. The manufacturing system can repeat this process for each test build in the set of test builds and each test value in the first set of test values.

In another implementation, the computer system can access a first set of measurements (e.g., a set of polymerized film thicknesses) representing a first part characteristic (e.g., Z-dimensional growth) exhibited by the set of test builds of the first test build. For example, the computer system can receive the first set of measurements—via a user interface—including: a first measurement of a first polymerized film thickness (e.g., 0.100 millimeters) of the first test build; and a second measurement of a second polymerized film thickness (0.138 millimeters) of the second test build.

In one implementation, the computer system can derive a first function defining a relationship between the set of test values of the second print parameter (i.e., the exposure durations within the first range) and the first part characteristic (i.e., Z-dimensional growth) based on the first set of measurements (i.e., the set of polymerized film thicknesses). More specifically, based on the first set of measurements, the computer system can derive the first function correlating total exposure energy and Z-dimensional growth of the material. Additionally, based on the first function and/or the first set of measurements, the computer system can further define: a critical energy of the material; depth of penetration coefficients; and boundaries for exposure duration with respect to Z-dimensional growth.

In another implementation, the computer system can store the first function as a first part characteristic in a first material profile associated with the material. Additionally, the computer system can store the first set of measurements and/or a range of values corresponding to the first part characteristic, including a minimum value (e.g., 0.100 millimeters) for the first part characteristic and a maximum value (e.g., 0.500 millimeters) for the first part characteristic.

Accordingly, the computer system can: generate a print file defining a virtual test model including multiple test builds and distinct combinations of print parameters to form each test build; serve the print file to the manufacturing system for execution; receive measurements representing physical (e.g., mechanical, geometric, aesthetic) results for each of these test builds; and derive a relationship between print parameters and the physical results. Therefore, the computer system can aid a user—exhibiting limited expertise in the manufacturing system—in calculating print parameters that achieve particular mechanical, geometric, and/or aesthetic design goals.

### 7. FUNCTION DERIVATION

Generally, the computer system can derive relationships between the print parameters and resulting part characteristics for a particular material based on test characteristics exhibited by the set of test builds. In one implementation, Blocks of the method S100 can include: accessing a set of test characteristics representing dimensional properties and mechanical properties of a set of test builds formed of a material; accessing a set of test print parameters executed by a set of additive manufacturing systems during fabrication of the set of test builds in Block S110; deriving a set of functions for the material relating a subset of part characteristics and a subset of print parameters based on the set of test characteristics, and the set of test print parameters in Block S120; and storing the set of functions in a material profile associated with the material in Block S125.

In this implementation, for a material, the computer system can: access a set of test characteristics representing dimensional properties and mechanical properties (e.g., surface finish, dimensional accuracy, tensile strength) of a set of test builds formed of the material; and access a set of test print parameters (e.g., layer thickness, exposure duration, print speed) executed by a set of additive manufacturing systems during fabrication of the set of test builds. The computer system can then: derive a set of functions for the material relating a subset of part characteristics and a subset of print parameters based on the set of test characteristics, and the set of test print parameters; and store the set of functions in a material profile associated with the material.

In one example, the computer system can derive a function relating surface finish and dimensional accuracy (i.e., part characteristics) to exposure duration and layer thickness (i.e., print parameters) by analyzing multiple test builds formed according to different print parameters. In particular, in this example, the computer system can: for a first test build, in the set of test builds, extract a first surface finish value (e.g., Glossiness Rating of 80) and a first dimensional accuracy value (e.g., ±0.1 mm) of the first test build from the set of test characteristics, the first test build printed according to a first exposure duration (e.g., 15 seconds) and a first layer thickness (e.g., 25 microns); and for a second test build, in the set of test builds, extract a second surface finish value (e.g., Glossiness Rating of 40) and a second dimensional accuracy value (e.g., ±0.3 mm) of the second test build from the set of test characteristics, the second test build printed according to a second exposure duration (e.g., 8 seconds) less than the first exposure duration and a second layer thickness (e.g., 100 microns) greater than the first layer thickness.

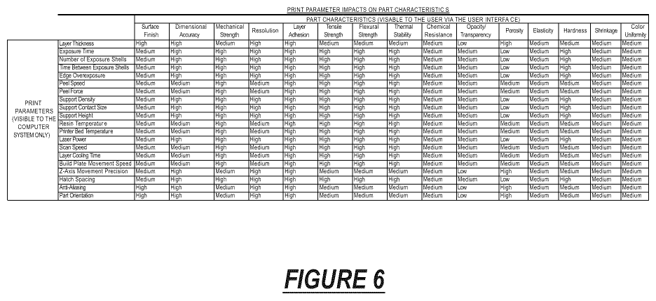

As shown in FIG. 6, the computer system can then identify relationships between each of the print parameters and resulting test characteristics exhibited by the test builds. In particular, the computer system can: derive a first function representing the relationship between a surface finish characteristic and an exposure duration parameter based on a second surface finish value less than the first surface finish value and the second exposure duration less than the first exposure duration; derive a second function representing the relationship between the surface finish characteristic and a layer thickness parameter based on the second surface finish value less than the first surface finish value and the second layer thickness greater than the first layer thickness; derive a third function representing the relationship between the dimensional accuracy characteristic and the exposure duration parameter based on the second dimensional accuracy value less than the first dimensional accuracy value and the second exposure duration less than the first exposure duration; and derive a fourth function representing the relationship between the dimensional accuracy characteristic and the layer thickness parameter based on the second dimensional accuracy value less than the first dimensional accuracy value and the second layer thickness greater than the first layer thickness.

The computer system can then repeat this process to derive a comprehensive set of functions representing the relationships between each test characteristic and test print parameter. Furthermore, the computer system can store the set of functions in the material profile associated with the material for later access when manufacturing a part of the same material. Therefore, the computer system can analyze and quantify the positive and/or negative correlations between test characteristics and print parameters to derive functions (e.g., linear, non-linear, interpolative, or extrapolative) for the material, thereby obviating the need for extensive iterative adjustments by the user to derive these functions.

### 7.1 Variation: Test Results

In one variation, the computer system can update the set of functions based on test results associated with the set of test builds. In particular, in this variation, the computer system can derive a set of functions for a material based on the first set of test characteristics representing dimensional properties and mechanical properties of the first set of test builds formed of the material and a first set of test print parameters executed during fabrication of the first set of test builds.

The computer system can then: perturb a first test characteristic value of a first test characteristic; derive a revised set of print parameter ranges that yield the perturbed first test characteristic value and the other nominal test characteristic values; and generate a print file for a second set of test builds based on the virtual test model of the second set of test builds and the revised set of print parameter ranges. Upon execution of the second set of test builds, the computer system can: identify a subset of test builds, in the second set of test builds, exhibiting a subset of test characteristics (i.e., satisfactory properties); access a subset of model layers defined in the virtual test model and corresponding to the subset of test builds; and access a subset of print parameter ranges, in the revised set of print parameter ranges, assigned to the subset of model layers and yielding the subset of test characteristics.

The computer system can then update the set of functions for the material based on the subset of print parameter ranges yielding the subset of test characteristics (i.e., satisfactory test characteristics). Therefore, the computer system can iteratively refine the set of functions based on test results of the test builds to better align with user-defined performance criteria and preferences.

### 8. TARGET PART INGEST

In one implementation, during a second time period succeeding the first time period, the computer system can: access (or “ingest”) a virtual part model (i.e., a three-dimensional virtual part model) representing a target part formed of a material, such as uploaded by a user or retrieved from a local or remote database. In this implementation, Blocks of the method S100 can include: accessing a virtual part model representing the target part formed of the material in Block S130. For example, the virtual part model can include: a solid computer-aided-drafting (or “CAD”) model representing a volume of the target part between its interior or exterior surfaces; or a mesh defining target interior and exterior surfaces of the target part.

### 9. PART CHARACTERISTIC PRESENTATION+PRINT PARAMETER GENERATION

Generally, the computer system can: receive and/or access a virtual part model of a target part to be formed of a material; render the set of part characteristics via a user interface to receive an input representing target values for the target part; access a material profile—corresponding to the material—defining a set of functions linking target properties to combinations of print parameters; receive one or more target values from the user corresponding to the part characteristics; calculate a set of print parameters corresponding to the one or more target values based on the set of functions; generate a print file defining the set of print parameters and the target part; and serve the print file to the manufacturing system for execution of an instance of the target part. In particular, the computer system can receive a target value (i.e., a minimum threshold value, maximum threshold value, a single value) or a target range (i.e., a minimum and maximum range) for each part characteristic.

In one implementation, Blocks of the method S100 can include, during the second time period: for a first part characteristic in a set of part characteristics, receiving a first target value from a user via a user interface executing on a computing device accessed by the user in Block S140; based on the set of functions, calculating a first set of print parameter ranges of a set of print parameters for the target part, limited by the first target value for the first part characteristic in Block S150; based on the set of functions, calculating a second part characteristic range of a second part characteristic in the set of part characteristics, limited by the first set of print parameter ranges; and presenting the second part characteristic range of the second part characteristic to the user via the user interface in Block S160.

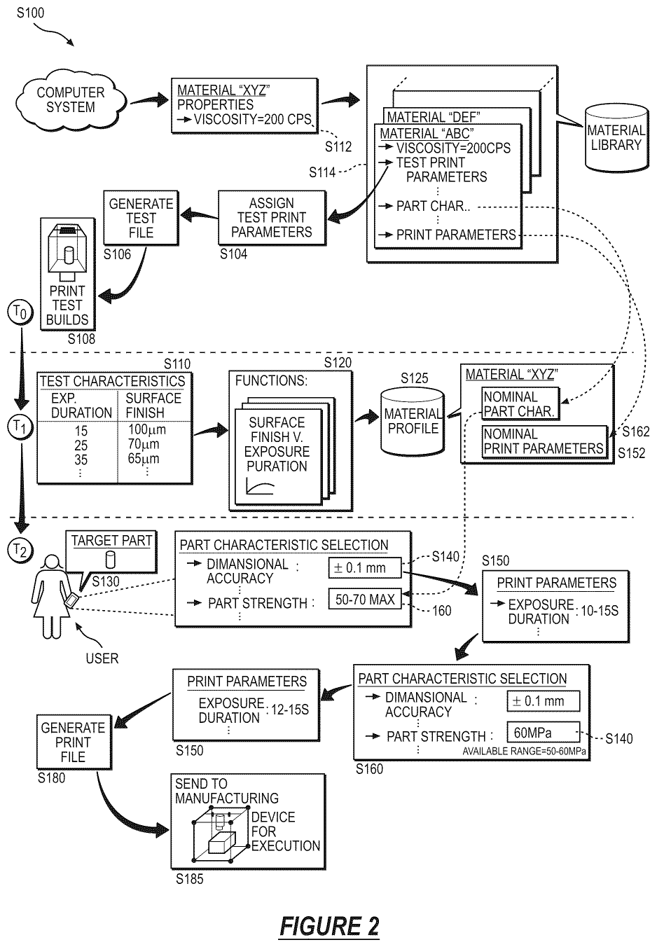

In this implementation, as shown in FIG. 2, during the second time period, the computer system can: access a virtual part model representing the target part formed of the material; for each part characteristic, in a set of part characteristics, present the part characteristic via the user interface adjacent a text box (i.e., an empty text box) configured to receive a target value from the user for the part characteristic; and, for a first part characteristic in a set of part characteristics, receive a first target value from the user via a first text box corresponding to the first part characteristic in the user interface. The computer system can then, based on the set of functions derived for the material: calculate a first set of print parameter ranges, of a set of print parameters for the target part, limited by the first target value for the first part characteristic; calculate a second part characteristic range of a second part characteristic in the set of part characteristics, limited by the first set of print parameter ranges; and present the second part characteristic range of the second part characteristic to the user via the user interface.

In one example, during the first time period, the computer system can: access a set of test characteristics representing a dimensional accuracy characteristic and a part strength characteristic of a set of test builds formed of a material; access a set of test print parameters including an exposure duration parameter executed by a set of additive manufacturing systems during fabrication of the set of test builds; derive a first function representing the relationship between the dimensional accuracy characteristic and the exposure duration parameter (i.e., exposure time per layer); derive a second function representing the relationship between the part strength characteristic and the exposure duration parameter; and store the first and second functions in the material profile associated with the material.

Then, during the second time period succeeding the first time period, the computer system can: access the virtual part model representing the target part formed of the material; present a set of 30 part characteristics to the user via the user interface, each part characteristic adjacent a text box configured to receive a target value from the user; and, for a dimensional accuracy characteristic (i.e., the first part characteristic), receive a target dimensional accuracy value of ±0.1 mm from the user via a first text box adjacent the dimensional accuracy characteristic in the user interface.

The computer system can then: calculate an exposure duration range between 25 seconds and 30 seconds (i.e., a print parameter range), the exposure duration range limited by the target dimensional accuracy value based on the first function; calculate a part strength range between 50 MPa and 70 MPa (i.e., a second part characteristic) limited by the exposure duration range based on the second function; and present the part strength range to the user (i.e., via a text box) adjacent the part strength characteristic in the user interface. The computer system can then repeat this process to iteratively update each part characteristic range upon receiving a user input to derive a set of viable print parameters for the target part. More specifically, the computer system can: receive a second target value, for a second part characteristic, within the second part characteristic range from the user via the user interface; and calculate a second set of print parameter ranges of the set of print parameters for the target part, limited by the first target value for the first part characteristic and the second target value for the second part characteristic.

For example, in the preceding example, the computer system can: for the part strength characteristic (i.e., the second part characteristic), receive a target part strength value of 70 MPa from the user via a second text box corresponding to the part strength characteristic in the user interface; and calculate a second exposure duration range between 27 seconds and 29 seconds, the second exposure duration range limited by the target dimensional accuracy value of ±0.1 mm and the target part strength value of 70 MPa and based on the first function. Thus, in response to receipt of each successive target value (or target range) from the user, the computer system can recalculate the set of print parameter ranges. Furthermore, in response to generating a viable set of part characteristics (i.e., part characteristics that are both accepted by the user and correspond to a viable set of print parameters), the computer system can: generate a print file for the target part based on the virtual part model of the target part and the second set of print parameter values; and serve the print file to an additive manufacturing system for execution during fabrication of an instance of the target part.

Accordingly, the computer system can: convert an input representing target mechanical, geometric, and/or aesthetic properties of the target part into the first set of print parameters; and serve a print file—defining the second set of print parameters and the virtual part model—that controls the manufacturing system to print the target part exhibiting these mechanical, geometric, and/or aesthetic properties corresponding to the target values input by the user. Therefore, the computer system can enable a user to control the manufacturing system and customize properties of the target part while obfuscating the print parameters from the user to prevent the user from utilizing the first set of print parameters on a different manufacturing system—for which the print parameters may be incompatible and/or yielding unexpected part characteristics—thereby mitigating risk of mechanical damage.

### 9.1 Variation: Print Parameters Based on Multiple Part Characteristic Inputs

In one variation, the computer system can derive a print parameter range dependent on multiple part characteristics. For example, in the preceding example, the computer system can: receive a target dimensional accuracy value of +0.1 mm from the user via the user interface; receive the target part strength value of 70 MPa from the user via user interface; and calculate a third set of print parameter ranges including a layer thickness of 50 microns based on the set of functions and limited by the dimensional accuracy value of ±0.1 mm and the part strength value of 70 MPa. Thus, the computer system can convert multiple target inputs impacting a single print parameter into a viable print parameter range.

### 10. NOMINAL PART CHARACTERISTICS+PRINT PARAMETERS

In one implementation, the computer system can automatically populate a nominal value and/or range adjacent each part characteristic in the user interface and access a set of nominal print parameter ranges for the material. In this implementation, Blocks of the method S100 can include: accessing a set of nominal part characteristic ranges, of the set of part characteristics, for the target part in Block S162; and calculating a set of nominal print parameter ranges, of the set of print parameters, for the target part based on the set of nominal part characteristic ranges and the set of functions in Block S152.

In particular, in this implementation, during the second time period, for each part characteristic, the computer system can: access a nominal part characteristic range corresponding to the part characteristic; and populate a text box adjacent the part characteristic with the nominal part characteristic range in the user interface. The computer system can then calculate a set of nominal print parameter ranges, of the set of print parameters, for the target part based on the set of nominal part characteristic ranges and the set of functions. In response to receiving the first target value corresponding to the first part characteristic, the computer system can calculate the first set of print parameter ranges by recalculating the set of nominal print parameter ranges based on the first target value for the first part characteristic. Thus, the computer system can present nominal part characteristic values to the user as a reference for the user when selecting the target values.

### 10.1 Variation: Analogous Materials

In one variation, the computer system can: access a set of nominal part characteristic values associated with an analogous material; and present the set of nominal part characteristic values to the user via the user interface as a reference during part characteristic selection for the target part. In this variation, Blocks of the method S100 can include: accessing a first material property of the material in Block S112; identifying a second material associated with a second material property analogous to the first material property in Block S114; and extracting a second set of functions associated with the second material from a library of material profiles in Block S116.

In particular, in this variation, the computer system can: access a virtual part model representing the target part formed of the material; access a first material property of the material; identify a second material associated with a second material property analogous to the first material property; extract a second set of part characteristic values associated with the second material from a library of material profiles; and populate a set of text boxes adjacent the set of part characteristics with the second set of part characteristic values. Additionally, in this variation, the computer system can: extract a second set of functions associated with the second material; and calculate the set of nominal print parameter ranges based on the second set of functions.

For example, the computer system can: access a viscosity of 200 centipoise of the material; identify a second material associated with a viscosity of 200 centipoise; access a dimensional accuracy characteristic value of ±0.2 mm from a second material profile associated with the second material; and populate a text box adjacent the dimensional accuracy characteristic with the dimensional accuracy characteristic value of ±0.2 mm. The computer system can then: access a layer thickness of 75 microns and an exposure duration of twelve seconds per layer from the second set of print parameters; and generate a print file for the target part including the layer thickness of 75 microns and the exposure duration of twelve seconds per layer. Therefore, the computer system can leverage analogous materials to establish reference print parameters and part characteristics.

### 10.2 Variation: User Preferences

In another variation, the computer system can access a set of nominal part characteristic values based on user preferences. In one example, the computer system can: access a virtual part model representing the target part formed of the material; receive identification of a user accessing the user interface; extract a preferred dimensional accuracy value of +0.1 mm from a user profile, in a population of user profiles, associated with the user; and populate a text box adjacent the dimensional accuracy characteristic with the dimensional accuracy value of +0.1 mm. Therefore, the computer system can leverage user preferences to establish reference part characteristics for the target part.

### 10.3 Variation: Boundary Values Defined by Functions

In another variation, the computer system can access a set of nominal part characteristic values based on minimum and maximum values of each part characteristic. In this variation, the computer system can implement a function—in the set of functions —setting a balance between a subset of part characteristics (e.g., a first part characteristic and a second part characteristic). For example, the computer system can implement the set of functions including: a first function representing a balance between print speed and dimensional accuracy; a second function representing a balance between dimensional accuracy and green strength; a third function representing a balance between rigidity and flexibility; and/or a fourth function representing a balance between surface smoothness and surface roughness.

In this implementation, the computer system can define the function within a range bounded by a lower boundary value (or a “lower boundary”) and an upper boundary value (or an “upper boundary”), the lower boundary corresponding to a minimum value of a first part characteristic and a minimum value of a second part characteristic, the upper boundary corresponding to a minimum value of the first part characteristic and a maximum value of the second part characteristic.

For example, the computer system can define the function bounded by the lower boundary value corresponding to: maximum print speed and minimum dimensional accuracy; maximum dimensional accuracy and minimum green strength; maximum rigidity and minimum flexibility; or maximum surface smoothness and minimum surface roughness. In this example, the computer system can define the function bounded by the upper boundary value corresponding to: minimum print speed and maximum dimensional accuracy; minimum dimensional accuracy and maximum green strength; minimum rigidity and maximum flexibility; or minimum surface smoothness and maximum surface roughness.

Additionally or alternatively, the computer system can derive the maximum value and the minimum value of a part characteristic based on a specification defining the maximum value and the minimum value of the part characteristic.

In one implementation, the computer system can derive a maximum value of a first part characteristic based on a minimum value of a second part characteristic. More specifically, the computer system can: access a subset of functions associated with the first part characteristic and the second part characteristic; calculate a first set of print parameters to yield the minimum value of the second part characteristic based on the subset of functions; and calculate the maximum value of the first part characteristic based on the first set of print parameters and the subset of functions. The computer system can map the lower boundary to the maximum value of the first part characteristic and the minimum value of the second part characteristic.

In this implementation, the computer system can also derive a maximum value of the second part characteristic based on a minimum value of the first part characteristic. More specifically, the computer system can: calculate a second set of print parameters to yield the minimum value of the first part characteristic based on the subset of functions; and calculate the maximum value of the second part characteristic based on the second set of print parameters and the subset of functions. The computer system can map the upper boundary to the minimum value of the first part characteristic and the maximum value of the second part characteristic.

Additionally, by defining the function within the range bounded by the lower boundary value and the upper boundary value, the computer system can generate a combination of print parameters based on the set of functions—within an operating range of the manufacturing system—that: yields a structure exhibiting physical properties according to specification defining minimum and/or maximum values of part characteristics; and prevents damage to the manufacturing system.

### 10.3.1 Example: Dimensional Accuracy v. Green Strength

In one example, the computer system renders an option (e.g., a slider) to set a balance between green strength and dimensional accuracy of the part. Generally, greater exposure power (i.e., intensity and/or duration) projected onto a part layer may produce more complete activation of a catalyst in the resin, increase a rate of polymerization of the resin, and yield greater green strength in the part layer. However, the increased rate and magnitude of polymerization of the resin due to greater exposure power may also induce uncontrolled polymerization beyond the exposure region, which may reduce dimensional and textural accuracy of the part layer. Therefore, if the user elects to increase green strength of the part at the expense of dimensional accuracy, the computer system can increase the average or maximum exposure power allocated to each print layer in the print file for the virtual part model. Conversely, if the user elects to increase dimensional accuracy of the part at the expense of green strength, the computer system can decrease the average or maximum exposure power allocated to the print layer in the print file for the three-dimensional virtual part model.

### 11. USER SELECTION OUTSIDE OF NOMINAL PART CHARACTERISTIC

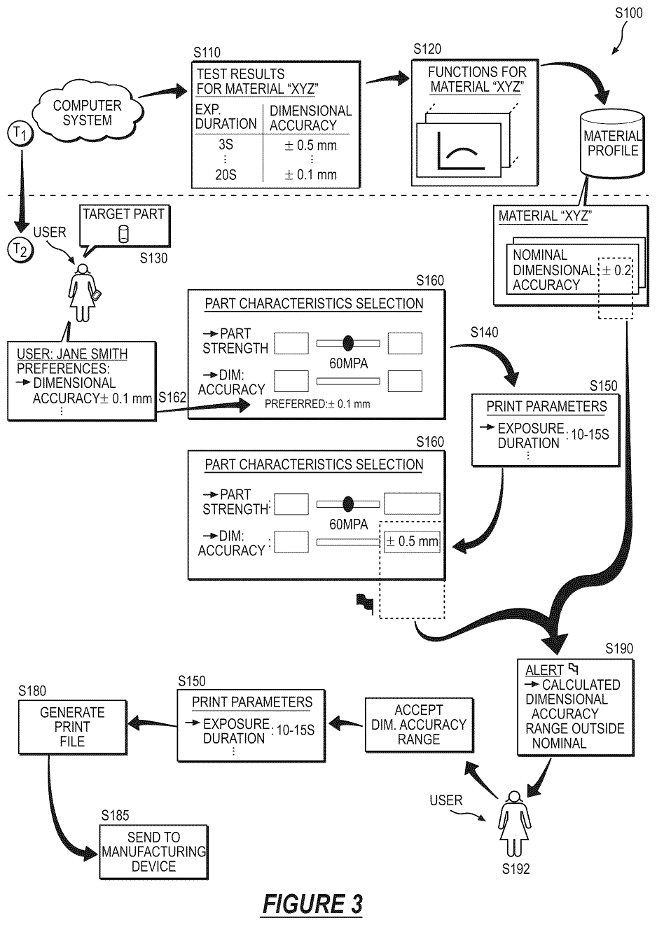

In another variation, as shown in FIG. 3, the computer system can alert the user in response to receiving a target value for a part characteristic outside of the nominal range defined for the part characteristic. In this variation, Blocks of the method S100 can include: generating a notification including a prompt to review the first target value for the first part characteristic in Block S190; and transmitting the notification to the user via the user interface in Block S192.

In this variation, the computer system can receive a first target value from the user for a first part characteristic. The computer system can then, based on the set of functions: calculate the first set of print parameter ranges limited by the first target value for the first part characteristic; and calculate the second part characteristic range of the second part characteristic, limited by the first set of print parameter ranges. In particular, in this variation, in response to calculating the second part characteristic range excluding a nominal part characteristic value (e.g., a nominal value defined for a similar material) corresponding to the second part characteristic, the computer system can: generate a notification including a prompt to review the first target value for the first part characteristic; and transmit the notification to the user via the user interface.

Additionally or alternatively, in this variation, in response to receiving a second target value from the user for the second part characteristic outside of a nominal part characteristic range defined for the second part characteristic, the computer system can: generate a notification including a prompt to review the second target value for the second part characteristic; and transmit the notification to the user via the user interface.

### 12. VARIATION: INVALID PRINT PARAMETER RANGE

In another variation, the computer system can alert the user in response to calculating an invalid range for one or more print parameters based on the user-specified part characteristics. In this variation, the computer system can receive a first target value from the user for a first part characteristic. The computer system can then, based on the set of functions: calculate the first set of print parameter ranges limited by the first target value for the first part characteristic; and calculate the second part characteristic range of the second part characteristic, limited by the first set of print parameter ranges. In particular, in this variation, in response to calculating an invalid range for a particular print parameter, the computer system can: generate a notification including a prompt to review the first target value for the first part characteristic and the second target value for the second part characteristic; and transmit the notification to the user via the user interface.

### 12. VARIATION: USER-ADJUSTABLE SLIDERS

In one variation, as shown in FIG. 3, the computer system can present each part characteristic adjacent a range selector interface (e.g., a slider, dial, radio button) configured for adjustability by the user to the target value corresponding to the part characteristic. In one example, during the second time period, the computer system can present the first part characteristic, via the user interface, adjacent a first slider, the first slider: interposed between a first text box indicating a first lower boundary of the first part characteristic range and a second text box indicating a first upper boundary of the first part characteristic range; and configured for adjustability by the user to receive the first target value corresponding to the first part characteristic. The computer system can further present the second part characteristic, via the user interface, adjacent a second slider, the second slider: interposed between a third text box indicating a second lower boundary of the second part characteristic range and a fourth text box indicating a second upper boundary of the second part characteristic range; and configured for adjustability by the user to receive the second target value corresponding to the second part characteristic.

In particular, in this example, based on the set of functions, the computer system can calculate: the first lower boundary and the first upper boundary of the first part characteristic; and the second lower boundary and the second upper boundary of the second part characteristic. The computer system can then populate: the first text box with the first lower boundary; the second text box with the first upper boundary; the third text box with the second lower boundary; and the fourth text box with the second upper boundary. In response to receiving the first target value from the user via adjustment of the first slider by the user, the computer system can: recalculate the second lower boundary and the second upper boundary of the second part characteristic limited by the first target value and based on the set of functions; and populate the third and fourth text boxes with the updated lower and upper boundaries, respectively.

In another example, the computer system can present the first part characteristic, via the user interface, adjacent a first set of radio buttons. In particular, the computer system can: segment the first part characteristic range into a subset of ranges; and present a set of radio buttons, each adjacent a sub-range of the first part characteristic range.

Accordingly, the computer system can: convert a target input received via adjustment of the slider into a set of print parameters; and serve a print file-defining the set of print parameters and the virtual part model—that controls the manufacturing system to print the target part exhibiting these mechanical, geometric, and/or aesthetic properties corresponding to the target values input by the user.

### 13. PART CHARACTERISTIC ORDER

In one variation, the computer systems arrange the set of part characteristics in the user interface according to a predefined sequence, such as based on extant user preferences. In particular, in this variation, the computer system can: access the virtual part model representing the target part formed of the material; receive identification of the user accessing the user interface; extract a primary part characteristic (e.g., a dimensional accuracy characteristic) from a user profile, in a population of user profiles, associated with the user; and present the primary part characteristic in a first slot in the user interface.

Thus, the computer system can: order the set of part characteristics by prioritizing part characteristics previously designated as critical by the user (e.g., in the user's profile or in a last print file generated by the user); and sort critical part characteristics at the forefront of the part characteristic list according to this order. Accordingly, the computer system can: enable or prompt the user to first enter part characteristics that are of greatest priority to the user; calculate print parameters that enable these highest-priority part characteristics and that (necessarily) limit options for remaining part characteristics; enable or prompt the user to enter part characteristics that are of lower priority to the user; and then calculate additional print parameters that enable both highest-priority and lower-priority part characteristics.

### 13.1 Variation: Part Characteristic Sensitivity

In another variation, the computer system can arrange the set of part characteristics in a predefined sequence according to their sensitivity metrics, which quantify the extent to which alterations in one part characteristic influence the values of other characteristics. In particular, in this variation, the computer system can: for each part characteristic in the set of part characteristics, access a quantity of impacted part characteristics (e.g., changing the dimensional accuracy value impacts ten other part characteristic ranges) from the set of functions; and arrange the set of part characteristics in the user interface by descending quantity of impacted part characteristics.

In one implementation, the computer system can: access a set of nominal part characteristic values from a material profile for a material, such as nominal part characteristic values that are common for the user or selected previously by the user for an analogous material; and calculate a set of nominal print parameter ranges that yield the nominal part characteristic values based on a set of functions in the material profile. The computer system can then, for a first part characteristic: perturb a first part characteristic value of the first part characteristic; based on the material profile, calculate a set of revised print parameter ranges that yield the perturbed first part characteristic value and the other nominal part characteristic values; and characterize sensitivity of the first part characteristic proportional to a deviation of the revised print parameter ranges from the nominal print parameter ranges. The computer system can then repeat this process for each other part characteristic: to calculate a sensitivity (or “impact”) of each part characteristic to the print parameters; and to present the part characteristics—in descending order of sensitivity—to the user.

In a similar implementation, the computer system can: access the set of nominal part characteristic values from the material profile for the material, such as nominal part characteristic values that are common for the user or selected previously by the user for an analogous material; and calculate a set of nominal print parameter ranges that yield the nominal part characteristic values based on the set of functions in the material profile. The computer system can then, for a first part characteristic: perturb a first part characteristic value of the first part characteristic; based on the material profile, calculate a set of revised print parameter ranges that yield the perturbed first part characteristic value; based on the set of revised print parameter ranges, calculate a set of revised part characteristic ranges; and characterize sensitivity of the first part characteristic proportional to a maximum or average reduction in the part characteristic ranges of each other part characteristic resulting from such perturbation of the first part characteristic. The computer system can then repeat this process for each other part characteristic: to calculate a sensitivity (or “impact”) of each part characteristic to each other part characteristic; and to present the part characteristics—in descending order of sensitivity—to the user.

For example, for a dimensional accuracy characteristic, the computer system can: access a nominal dimensional accuracy value for a material; perturb the nominal dimensional accuracy value of the dimensional accuracy characteristic; calculate a set of revised part characteristic ranges based on the perturbed dimensional accuracy value; and identify a set of ten part characteristic ranges, in the set of revised part characteristic ranges, impacted by the perturbed dimensional accuracy value. The computer system can then, for a color uniformity characteristic: access a nominal color uniformity value for a material; perturb the nominal color uniformity value of the color uniformity characteristic; calculate a set of revised part characteristic ranges based on the perturbed color uniformity value; and identify a set of two part characteristic ranges, in the set of revised part characteristic ranges, impacted by the perturbed color uniformity value. In particular, in this example, the computer system can sort the part characteristics such that the dimensional accuracy characteristic is arranged in a first slot in the user interface, and the color uniformity characteristic is arranged in a second slot, below the first slot, in the user interface.

Thus, the computer system can: order the set of part characteristics by prioritizing part characteristic sensitivity; and sort higher-sensitivity part characteristics at the forefront of the part characteristic list according to this order. Accordingly, the computer system can: access nominal part characteristic values for a material; perturb each nominal part characteristic value; record the impact that each perturbed part characteristic value imposes on each other part characteristic range; characterize sensitivity of each part characteristic based on the impacts of the perturbed part characteristic value; and arrange the part characteristics in the user interface according to their sensitivity metrics such that part characteristics with significant impacts on the other part characteristics are prioritized. Therefore, the computer system can mitigate the need for iterative adjustments and reconfiguration by addressing the most impactful part characteristics first, thereby reducing the likelihood of restarting the part characteristic selection from the beginning.

### 14. QUALITATIVE USER INPUTS

In another variation, the computer system can derive the set of part characteristic ranges based on qualitative part characteristic inputs from the user. In one example, the computer system can derive part characteristics and print parameters for a target part based on user input specifying that stringent dimensional precision is not necessary and rapid production is a priority. In particular, in this example, the computer system can: receive selection of a part function of the target part (i.e., a preliminary prototype for a tool) from the user; receive selection of a preferred build time of less than four hours; derive a set of part characteristics including a dimensional accuracy tolerance of ±0.30 mm; and derive a set of print parameters including an exposure duration of three seconds per layer. Therefore, based on qualitative inputs from the user, the computer system can derive part characteristics and print parameters to align with the requirements of the target component, thereby minimizing user interaction with the computer system throughout the process.

### 15. PRINT FILE GENERATION

In one implementation, Blocks of the method S100 can include: generating the print file for the target part based on the virtual part model of the target part and the second set of print parameter ranges in Block S180; and serving the print file to an additive manufacturing system for execution during fabrication of an instance of the target part in Block S185. In particular, the computer system can: access the virtual part model of the target part formed of the material; access the set of derived print parameters for the target part; and assign the set of print parameters (e.g., an exposure duration and a layer thickness) to the virtual part model.

### 15.1 Vertical Part Segmentation

In one variation, as shown in FIG. 4, the computer system can: receive two different values of a particular part characteristic corresponding to different surfaces and/or regions of the virtual part model; and assign subsets of unique print parameters to the different surfaces and/or regions of the virtual part model based on the different values of the part characteristic received from the user.

In particular, in this variation, the computer system can: receive a first value of a first part characteristic for a first surface of the virtual part model; and receive a second value (i.e., greater than or less than the first value) of the first part characteristic for a second surface of the virtual part model. The computer system can then, based on the material profile: calculate a first subset of print parameters that yield the first value of the first part characteristic; and calculate a second subset of print parameter ranges that yield the second value of the first part characteristic.

The computer system can then: define a vertical print axis of the virtual part model; define a set of model layers of the virtual part model normal to the vertical print axis; assign the first subset of print parameters to a first model layer in the set of model layers intersecting the first surface; assign the second subset of print parameters to a second model layer in the set of model layers intersecting the second surface; and generate the print file including the first and second model layers and the first and second subsets of print parameters represented in a set of print images for execution by an additive manufacturing system configured to selectively expose layers of resin according to the set of print images in the print file to manufacture the target part. Therefore, the computer system can generate a print file representing a set of print parameters and a set of frames corresponding to cross-sections (e.g., full cross-sections, partial cross-sections) of a virtual part model of the target part, thereby ensuring that the part meets the required specifications across all cross-sections effectively.

In one example, the computer system can receive two different surface finish values for two different surfaces of the target part. In this example, the computer system can: receive a first surface finish value corresponding to a first surface of the target part; receive a second surface finish value corresponding to a second surface of the target part; calculate a first subset of print parameter values including a first layer thickness based on the first surface finish; and calculate a second subset of print parameter values including a second layer thickness based on the second surface finish.

The computer system can then: segment the virtual part model into a set of model layers; for a first model layer, in the set of model layers, intersecting the first surface, assign the first layer thickness to the first model layer; for a second model layer, in the set of model layers, intersecting the second surface, assign the second layer thickness to the second model layer; and compile the first and second model layers and the first and second layer thicknesses into a set of print images in the print file for execution by a first additive manufacturing system.

### 15.2 Surface Segmentation

In one variation, the computer system can: receive a first set of part characteristic values associated with a first surface of the virtual part model from the user via the user interface; and receive a second set of part characteristic values associated with a second surface of the virtual part model from the user via the user interface. In this variation, the computer system can then: access a nominal layer thickness value, such as a minimum layer thickness value indicated by the first and second sets of part characteristic values; and segment the virtual part model into the set of model layers according to the nominal layer thickness value. The computer system can then: for each layer, isolate a set of distinct edges of the layer, each edge assigned to a different set of part characteristics; and for each edge of the layer and adjacent volume of the layer, calculate and assign a set of print parameters based on the corresponding set of part characteristics. The computer system can then assemble the layers and sets of print parameters into a print file for execution by the additive manufacturing system.

### 15.3 Target Part Results

In one variation, the computer system can update the set of functions based on results associated with the target part manufactured according to the print file. For example, the computer system can receive user feedback specifying a surface finish value—for a sidewall of the target part—falls below a surface finish threshold. In this variation, based on the user feedback and/or test results, the computer system can update a subset of functions, in the set of functions, linking the surface finish characteristic to a subset of print parameters.

### 16. CONCLUSION

The computer systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for generating a print file for a target part, the method comprising:
during a first time period:
accessing a set of test characteristics representing dimensional properties and mechanical properties of a set of test builds formed of a material;
accessing a set of test print parameters executed by a set of additive manufacturing systems during fabrication of the set of test builds;
deriving a set of functions for the material relating a subset of part characteristics and a subset of print parameters based on:
the set of test characteristics; and
the set of test print parameters; and
storing the set of functions in a material profile associated with the material; and
during a second time period succeeding the first time period:
accessing a virtual model representing the target part formed of the material;
for a first part characteristic in a set of part characteristics, receiving a first target value from a user via a user interface executing on a computing device accessed by the user;
based on the set of functions:
calculating a first set of print parameter ranges of a set of print parameters for the target part, limited by the first target value for the first part characteristic; and
calculating a second part characteristic range of a second part characteristic in the set of part characteristics, limited by the first set of print parameter ranges;
presenting the second part characteristic range of the second part characteristic to the user via the user interface;
receiving a second target value, for the second part characteristic, within the second part characteristic range from the user via the user interface;
calculating a second set of print parameter ranges of the set of print parameters for the target part, based on the set of functions and limited by the first target value for the first part characteristic and the second target value for the second part characteristic;
generating the print file for the target part based on the virtual model of the target part and the second set of print parameter ranges; and
serving the print file to an additive manufacturing system for execution during fabrication of an instance of the target part.

2. The method of claim:
further comprising, during the first time period:
accessing a set of nominal part characteristic ranges, of the set of part characteristics, for the target part; and
calculating a set of nominal print parameter ranges, of the set of print parameters, for the target part based on the set of nominal part characteristic ranges and the set of functions; and
wherein calculating the first set of print parameter ranges during the second time period comprises recalculating the set of nominal print parameter ranges based on the first target value for the first part characteristic.

3. The method of claim:
further comprising, during an initial time period preceding the first time period:
accessing a first material property of the material;
identifying a second material associated with a second material property analogous to the first material property; and
extracting a second set of functions associated with the second material from a library of material profiles; and
wherein calculating the set of nominal print parameter ranges during the first time period comprises calculating the set of nominal print parameter ranges based on the second set of functions.

4. The method of claim:
further comprising, during the second time period, receiving identification of the user accessing the user interface;
wherein accessing the set of nominal part characteristic ranges during the first time period comprises extracting a first preferred part characteristic value from a user profile, in a population of user profiles, associated with the user, the first preferred part characteristic value corresponding to the first part characteristic; and
further comprising, during the second time period, presenting the first preferred part characteristic value adjacent the first part characteristic in the user interface.

5. The method of claim, further comprising, during an initial time period preceding the first time period:
accessing a first material property of the material;
identifying a second material associated with a second material property analogous to the first material property;
assigning the set of test print parameters to the set of test builds based on a second set of test print parameters executed by the set of additive manufacturing systems during fabrication of a second target part formed of the second material;
generating a test print file for the set of test builds formed of the material based on the set of print parameters; and
serving the test print file to the set of additive manufacturing systems for execution during fabrication of the set of test builds.

6. The method of claim:
further comprising, during the first time period:
accessing a set of nominal part characteristic ranges, of the set of part characteristics, for the target part including a second nominal part characteristic value corresponding to the second part characteristic;
wherein calculating the second part characteristic range of the second part characteristic during the second time period comprises calculating the second part characteristic range excluding the second nominal part characteristic value; and
further comprising, during the second time period:
generating a notification comprising a prompt to review the first target value for the first part characteristic; and
transmitting the notification to the user via the user interface.

7. The method of claim:
wherein receiving the first target value during the second time period comprises receiving a target dimensional accuracy value corresponding to a dimensional accuracy characteristic from the user via the user interface;
wherein receiving the second target value during the second time period comprises receiving a target part strength value corresponding to a part strength characteristic from the user via the user interface; and
wherein calculating the second set of print parameter ranges during the second time period comprises calculating an exposure duration range for an exposure duration parameter based on a function representing a relationship between the dimensional accuracy characteristic, the part strength characteristic, and the exposure duration parameter and limited by the target dimensional accuracy value and the target part strength value.

8. The method of claim:
wherein receiving the first target value for the first part characteristic during the second time period comprises receiving:
a first surface finish value corresponding to a first surface of the target part; and
a second surface finish value corresponding to a second surface of the target part;
wherein calculating the second set of print parameter ranges during the second time period comprises:
calculating a first layer thickness value based on the first surface finish value; and
calculating a second layer thickness value based on the second surface finish value; and
wherein generating the print file for the target part during the second time period comprises:
segmenting the virtual model into a set of model layers;
for a first model layer, in the set of model layers, intersecting the first surface, assigning the first layer thickness value to the first model layer;
for a second model layer, in the set of model layers, intersecting the second surface, assigning the second layer thickness value to the second model layer; and
compiling the first model layer, the second model layer, the first layer thickness value and the second layer thickness value into a set of print images in the print file for execution by a first additive manufacturing system configured to selectively expose layers of resin according to print images in the print file to manufacture the target part.

9. The method of claim:
further comprising, during the second time period, in response to calculating the second set of print parameter ranges comprising an invalid range for a first print parameter:
generating a notification comprising a prompt to review the first target value for the first part characteristic and the second target value for the second part characteristic; and
transmitting the notification to the user via the user interface.

10. The method of claim:
further comprising, during the second time period:
presenting the first part characteristic, via the user interface, adjacent a first slider, the first slider:
interposed between a first text box indicating a first lower boundary of a first part characteristic range and a second text box indicating a first upper boundary of the first part characteristic range; and
configured for adjustability by the user to receive the first target value corresponding to the first part characteristic; and
presenting the second part characteristic, via the user interface, adjacent a second slider, the second slider:
interposed between a third text box indicating a second lower boundary of the second part characteristic range and a fourth text box indicating a second upper boundary of the second part characteristic range; and
configured for adjustability by the user to receive the second target value corresponding to the second part characteristic;
wherein receiving the first target value from the user during the second time period comprises receiving the first target value via adjustment of the first slider by the user; and,
wherein receiving the second target value from the user during the second time period comprises receiving the second target value via adjustment of the second slider by the user.

11. The method of claim:
further comprising, during an initial time period preceding the first time period:
accessing a subset of functions, in the set of functions, associated with the first part characteristic and the second part characteristic; and
calculating the second lower boundary and the second upper boundary of the second part characteristic range based on the subset of functions;
wherein presenting the second part characteristic during the second time period comprises presenting the second part characteristic, via the user interface, adjacent the second slider by:
populating the third text box with the second lower boundary of the second part characteristic range; and
populating the fourth text box with the second upper boundary of the second part characteristic range; and
further comprising, in response to receiving the first target value, for the first part characteristic:
recalculating an updated lower boundary and an updated upper boundary of the second part characteristic range based on the set of functions and limited by the first set of print parameter ranges;
populating the third text box with the updated lower boundary of the second part characteristic range; and
populating the fourth text box with the updated upper boundary of the second part characteristic range.

12. The method of claim:
wherein accessing the set of test characteristics representing dimensional properties and mechanical properties of the set of test builds formed of the material during the first time period comprises:
for a first test build, in the set of test builds, extracting a first surface finish value and a first dimensional accuracy value of the first test build from the set of test characteristics; and
for a second test build, in the set of test builds, extracting a second surface finish value and a second dimensional accuracy value of the second test build from the set of test characteristics;
wherein accessing the set of test print parameters executed by the set of additive manufacturing systems during fabrication of the set of test builds during the first time period comprises:
for the first test build, accessing a first exposure duration and a first layer thickness; and
for the second test build, accessing a second exposure duration less than the first exposure duration and a second layer thickness greater than the first layer thickness; and
wherein deriving the set of functions for the material during the first time period comprises:
deriving a first function representing a first relationship between a surface finish characteristic and an exposure duration parameter based on the second surface finish value less than the first surface finish value and the second exposure duration less than the first exposure duration;
deriving a second function representing a second relationship between the surface finish characteristic and a layer thickness parameter based on the second surface finish value less than the first surface finish value and the second layer thickness greater than the first layer thickness;
deriving a third function representing a third relationship between a dimensional accuracy characteristic and the exposure duration parameter based on the second dimensional accuracy value less than the first dimensional accuracy value and the second exposure duration less than the first exposure duration; and
deriving a fourth function representing a fourth relationship between the dimensional accuracy characteristic and the layer thickness parameter based on the second dimensional accuracy value less than the first dimensional accuracy value and the second layer thickness greater than the first layer thickness.

13. The method of claim, further comprising:
during an initial time period preceding the first time period:
generating a cure characterization test file defining a first set of test builds arranged across a build area, each test build characterized by a total exposure energy value;
photocuring the first set of test builds by, for each test build, selectively exposing the material to an exposure energy corresponding to the total exposure energy value characterizing the test build;
accessing a first set of physical measurements representing a depth of cure for each test build;
calculating a working curve of the material based on the first set of physical measurements;
for assessing a dimensional accuracy characteristic:
generating a second test file based on the working curve of the material, the second test file defining the set of test builds, each test build in the set of test builds:
characterized by an exposure intensity value and an exposure duration value corresponding to a total exposure energy value greater than a target exposure energy of the material;
defining a positive stepped pyramid, each level of the positive stepped pyramid characterized by a positive target dimension; and
defining a negative stepped pyramid, each level of the negative stepped pyramid characterized by a negative target dimension; and
photocuring the set of test builds based on the second test file by, for each test build in the set of test builds:
photocuring volumes of the material via exposure to electromagnetic radiation, according to the exposure intensity value and the exposure duration value characterizing the test build, to form a positive stepped pyramid of the test build; and
photocuring volumes of the material via exposure to electromagnetic radiation, according to the exposure intensity value and the exposure duration value characterizing the test build, to form a negative stepped pyramid of the test build;
wherein accessing the set of test characteristics during the second time period comprises accessing a second set of physical measurements of the set of test builds, the second set of physical measurements representing, for each test build in the set of test builds:
a set of positive measured dimensions corresponding to positive target dimensions of levels of a positive step pyramid of the test build; and
a set of negative measured dimensions corresponding to negative target dimensions of levels of a negative step pyramid of the test build; and
wherein deriving the set of functions for the material during the second time period comprises deriving a function representing a relationship between the dimensional accuracy characteristic, an exposure intensity parameter and an exposure duration parameter by:
for each test build in the set of test builds, calculating a measured dimensional accuracy based on the set of positive measured dimensions for the test build and the set of negative measured dimensions for the test build;
selecting a subset of satisfactory test builds based on the measured dimensional accuracy for each test build in the set of test builds; and
deriving the first function for the material based on the exposure intensity value and the exposure duration value characterizing each test build in the subset of satisfactory test builds.

14. The method of claim:
wherein photocuring the first set of test builds during the initial time period comprises photocuring the first set of test builds via a first additive manufacturing device;
wherein deriving the set of functions for the material relating the subset of part characteristics and the subset of print parameters during the first time period comprises deriving the set of functions for the material via a second additive manufacturing device; and
wherein serving the print file to the additive manufacturing system for execution during fabrication of the instance of the target part during the second time period comprises serving the print file to a third additive manufacturing device.

15. The method of claim:
further comprising, during an initial time period preceding the first time period:
generating a cure characterization test file defining a first set of test builds arranged across a build area, each test build characterized by a total exposure energy value;
photocuring the first set of test builds by, for each test build, selectively exposing the material to an exposure energy corresponding to the total exposure energy value characterizing the test build;
accessing a first set of physical measurements representing a depth of cure for each test build;
calculating a working curve of the material based on the first set of physical measurements;
for assessing a surface roughness characteristic:
generating a second test file based on the working curve of the material, the second test file defining the set of test builds, each test build in the set of test builds:
characterized by an exposure intensity value and an exposure duration value corresponding to a total exposure energy value greater than a target exposure energy of the material; and
defining a horizontal section of a contiguous column; and
photocuring the set of test builds based on the second test file by, for each test build in the set of test builds, photocuring the horizontal section of the contiguous column for the test build via exposure to electromagnetic radiation according to the exposure intensity value and the exposure duration value characterizing the test build;
wherein accessing the set of test characteristics during the second time period comprises accessing a second set of physical measurements of the set of test builds, the second set of physical measurements representing, for each test build in the set of test builds, a measured surface roughness parameter of the horizontal section of the contiguous column; and
wherein deriving the set of functions for the material during the second time period comprises deriving a function representing a relationship between the surface roughness characteristic, an exposure intensity parameter and an exposure duration parameter by:
selecting a subset of satisfactory test builds based on the measured surface roughness parameter for each test build in the set of test builds; and
calculating an exposure intensity range for the material based on the exposure intensity value characterizing each test build in the subset of satisfactory test builds.

16. A method for generating a print file for a target part, the method comprising:
during a first time period:
accessing a set of test characteristics representing dimensional properties and mechanical properties of a set of test builds formed of a material;
accessing a set of test print parameters executed by a set of additive manufacturing systems during fabrication of the set of test builds;
deriving a set of functions for the material relating a subset of part characteristics and a subset of print parameters based on:
the set of test characteristics; and
the set of test print parameters; and
storing the set of functions in a material profile associated with the material; and
during a second time period succeeding the first time period:
accessing a virtual model representing the target part formed of the material;
for a first part characteristic in a set of part characteristics:
presenting the first part characteristic to a user via a user interface executing on a computing device accessed by the user; and
receiving a first target value via adjustment of a first slider by the user;
based on the set of functions:
calculating a first set of print parameter ranges of a set of print parameters for the target part, limited by the first target value for the first part characteristic; and
calculating a second part characteristic range of a second part characteristic in the set of part characteristics, limited by the first set of print parameter ranges;
presenting the second part characteristic range of the second part characteristic to the user via the user interface;
receiving a second target value, for the second part characteristic, within the second part characteristic range via adjustment of a second slider by the user;
calculating a second set of print parameter ranges of the set of print parameters for the target part, limited by the first target value for the first part characteristic and the second target value for the second part characteristic;
generating the print file for the target part based on the virtual model of the target part and the second set of print parameter ranges; and
serving the print file to an additive manufacturing system for execution during fabrication of an instance of the target part.

17. The method of claim:
further comprising, during an initial time period preceding the first time period:
accessing a first material property of the material;
identifying a second material associated with a second material property analogous to the first material property; and
accessing a set of nominal part characteristic ranges associated with the second material from a second material profile in a library of material profiles; and
wherein presenting the second part characteristic during the second time period comprises presenting the second part characteristic, via the user interface, adjacent the second slider by:
populating a first text box with a nominal lower boundary of a nominal part characteristic range corresponding to the second part characteristic; and
populating a second text box with a nominal upper boundary of the nominal part characteristic range corresponding to the second part characteristic.

18. The method of claim:
further comprising, during an initial time period preceding the first time period:
accessing a subset of functions, in the set of functions, associated with the first part characteristic and the second part characteristic; and
calculating a lower boundary and an upper boundary of the second part characteristic range based on the subset of functions;
wherein presenting the second part characteristic during the second time period comprises presenting the second part characteristic, via the user interface, adjacent the second slider by:
populating a first text box with the lower boundary of the second part characteristic range; and
populating a second text box with the second upper boundary of the second part characteristic range; and
further comprising, in response to receiving the first target value, for the first part characteristic:
recalculating a second lower boundary and a second upper boundary of the second part characteristic based on the set of functions and limited by the first set of print parameter ranges;
populating a first text box with the second lower boundary of the second part characteristic range; and
populating a second text box with the second upper boundary of the second part characteristic range.

19. The method of claim:
wherein receiving the first target value during the second time period comprises receiving a target dimensional accuracy value corresponding to a dimensional accuracy characteristic from the user via the user interface;
wherein receiving the second target value during the second time period comprises receiving a target part strength value corresponding to a part strength characteristic adjustment of the second slider by the user; and
wherein calculating the second set of print parameter ranges during the second time period comprises calculating an exposure duration range for an exposure duration parameter based on a function representing a relationship between the dimensional accuracy characteristic and the exposure duration parameter and limited by the target dimensional accuracy value and the target part strength value.

20. A method for generating a print file for a target part, the method comprising:
during a first time period:
accessing a set of test characteristics of a set of test builds formed of a material;
accessing a set of test print parameters executed during fabrication of the set of test builds;
deriving a set of functions for the material relating a subset of part characteristics and a subset of print parameters based on:
the set of test characteristics; and
the set of test print parameters; and
storing the set of functions in a material profile associated with the material; and
during a second time period succeeding the first time period:
accessing a virtual model representing the target part formed of the material;
for a first part characteristic in a set of part characteristics, receiving a first target value from a user via a user interface;
based on the set of functions, calculating a first set of print parameter ranges of a set of print parameters for the target part, limited by the first target value for the first part characteristic;
generating the print file for the target part based on the virtual model of the target part and the first set of print parameter ranges; and
serving the print file to an additive manufacturing system for execution during fabrication of an instance of the target part.
